(19) United States
(12) Patent Application Publication
(10) Pub. No.: US 2026/0292839 A1
(43) Pub. Date: Sep. 24, 2026

(54) DEVICES AND METHODS FOR COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 19/167,986

(22) PCT Filed: Mar. 24, 2023
(86) PCT No.: PCT/CN2023/083860

§ 371 Date: Sep. 23, 2025

(51) Int. Cl. H04W 72/232; H04W 72/231

(52) U.S. Cl. CPC H04W 72/232; H04W 72/231

(57) ABSTRACT

Embodiments of the present disclosure provide a solution for transmission configuration indicator (TCI) selection. In the solution, a terminal device receives, a first message comprising a first configuration indicating a selection of TCI state; and determines, a set of TCI states intended for the selection of TCI state based on one or more relationship between a TCI selection field and a TCI field. In this way, the terminal device may interpret the TCI-related configuration and select TCI state(s) properly.

### FIELDS

Example embodiments of the present disclosure generally relate to the field of communication techniques and in particular, to devices and methods for transmission configuration indicator (TCI) selection.

### BACKGROUND

Technology of multiple input multiple output (MIMO) has been widely used in current wireless communication system, where a large number of antenna elements are used by a network device for communicating with a terminal device. Further, in order to improve the reliability and robustness of the communication between the network device and the terminal device, technology of multi-transmission and reception point (multi-TRP/M-TRP) has been proposed and discussed.

Generally speaking, downlink control information (DCI) may be used by the network device to indicate the TCI-related information to the terminal device. It has been agreed that more than one TCI state may be indicated to the terminal device and the terminal device may select at least one TCT state for downlink transmissions (physical downlink shared channel, PDSCH). According to the agreements, information about the indicated TCI state(s) and information about TCI selection are indicated in different fields and further applied by the terminal device according to different timing control mechanism, which causes some scenarios where there are not TCI states for TCI selection or the terminal device is confused about which TCI states may be used for TCI selection. Thus, how to interpret the TCI configuration information is desirable to be discussed.

### SUMMARY

In general, embodiments of the present disclosure provide a solution for TCI selection.

In a first aspect, there is provided a terminal device comprising: a processor configured to cause the terminal device to: receive, a first message comprising a first configuration indicating a selection of transmission configuration indicator (TCI) state; and determine, a set of TCI states intended for the selection of TCI state based on at least one of the following: a first relationship between a first reception time point of receiving the first configuration and a second reception time point of receiving a second configuration indicating at least one TCI state, the second configuration being comprised in the first message or a second message, the second message being received prior to or after the first message, a second relationship between a first effective time point of the first configuration and a second effective time point of the second configuration, or a third relationship between a first frequency resource associated with the first configuration and a second frequency resource associated with the second configuration.

In second aspect, there is provided a terminal device comprising: a processor configured to cause the terminal device to: receive, from a network device, configuration information for the terminal device applying a first set comprising a first transmission configuration indicator (TCI) state and a second TCI state, the configuration information indicating a second set comprising a third TCI state to be used by the terminal device; and perform, by applying at least one TCI state, transmissions with the network device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In a third aspect, there is provided a terminal device comprising: a processor configured to cause the terminal device to: receive, from a network device, configuration information for the terminal device applying at least one transmission configuration indicator (TCI) state, the configuration information comprising a TCI selection field while without comprising a downlink assignment; and ignore the TCI selection field or determine at least one of first information or a second information from the TCI selection field, wherein, the first information indicates which one of the at least one TCI is to be updated, and the second information indicates whether to continue applying the other TCI state or only apply an indicated TCI state.

In a fourth aspect, there is provided a terminal device comprising: a processor configured to cause the terminal device to: receive, from a network device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In a fifth aspect, there is provided a network device comprising: a processor configured to cause the network device to: transmit, to a terminal device applying a first set comprising a first transmission configuration indicator (TCI) state and a second TCI state, configuration information for the terminal device, the configuration information indicating a second set comprising a third TCI state to be used by the terminal device; and perform, based on at least one TCI state, transmissions with the terminal device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In a sixth aspect, there is provided a network device comprising: a processor configured to cause the network device to: transmit, to a terminal device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In a seventh aspect, there is provided a communication method performed by a terminal device. The method comprises: receiving, a first message comprising a first configuration indicating a selection of transmission configuration indicator (TCI) state; and determining, a set of TCI states intended for the selection of TCI state based on at least one of the following: a first relationship between a first reception time point of receiving the first configuration and a second reception time point of receiving a second configuration indicating at least one TCI state, the second configuration being comprised in the first message or a second message, the second message being received prior to or after the first message, a second relationship between a first effective time point of the first configuration and a second effective time point of the second configuration, or a third relationship between a first frequency resource associated with the first configuration and a second frequency resource associated with the second configuration.

In an eighth aspect, there is provided a communication method performed by a terminal device. The method comprises: receiving, from a network device, configuration information for the terminal device applying a first set comprising a first transmission configuration indicator (TCI) state and a second TCI state, the configuration information indicating a second set comprising a third TCI state to be used by the terminal device; and performing, by applying at least one TCI state, transmissions with the network device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In a ninth aspect, there is provided a communication method performed by a terminal device. The method comprises: receiving, from a network device, configuration information for the terminal device applying at least one transmission configuration indicator (TCI) state, the configuration information comprising a TCI selection field while without comprising a downlink assignment; and ignoring the TCI selection field or determining at least one of first information or a second information from the TCI selection field, wherein, the first information indicates which one of the at least one TCI is to be updated, and the second information indicates whether to continue applying the other TCI state or only apply an indicated TCI state.

In a tenth aspect, there is provided a communication method performed by a terminal device. The method comprises: receiving, from a network device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In an eleventh aspect, there is provided a communication method performed by a network device. The method comprises: transmitting, to a terminal device applying a first set comprising a first transmission configuration indicator (TCI) state and a second TCI state, configuration information for the terminal device, the configuration information indicating a second set comprising a third TCI state to be used by the terminal device; and performing, based on at least one TCI state, transmissions with the terminal device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In a twelfth aspect, there is provided a communication method performed by a network device. The method comprises: transmitting, to a terminal device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In a thirteenth aspect, there is provided a computer readable medium having instructions stored thereon, the instructions, when executed on at least one processor, causing the at least one processor to carry out the method according to the seventh, eighth, ninth, tenth, eleventh or twelfth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. 1A to 1C illustrates example communication environments in which example embodiments of the present disclosure can be implemented;

FIG. 2 illustrates a signaling flow of communication in accordance with some embodiments of the present disclosure;

FIG. 3 illustrates an example block for TCI selection;

FIG. 4 illustrates an example structure of a signalling;

FIG. 5 illustrates another example structure of a signalling;

FIG. 6 illustrates another example structure of a signalling;

FIG. 7 illustrates another example block for TCI selection;

FIG. 8 illustrates another example block for TCI selection;

FIG. 9 illustrates another example block for TCI selection;

FIG. 10 illustrates an example mapping between different TCI state(s) and corresponding scenarios;

FIG. 11 illustrates an example timing for TCI selection;

FIGS. 12A and 12B illustrate example timings for TCI selection;

FIG. 13 illustrates another example timing for TCI selection;

FIG. 14 illustrates another example timing for TCI selection;

FIG. 15 illustrates another example timing for TCI selection;

FIGS. 16A and 16B illustrate example timings for TCI selection;

FIG. 17 illustrates an example timing for TCI selection;

FIG. 18 illustrates an example timing for TCI selection;

FIG. 19 illustrates a flowchart of a method implemented at a terminal device according to some example embodiments of the present disclosure;

FIG. 20 illustrates a flowchart of a method implemented at a terminal device according to some example embodiments of the present disclosure;

FIG. 21 illustrates a flowchart of a method implemented at a terminal device according to some example embodiments of the present disclosure;

FIG. 22 illustrates a flowchart of a method implemented at a terminal device according to some example embodiments of the present disclosure;

FIG. 23 illustrates a flowchart of a method implemented at a network device according to some example embodiments of the present disclosure;

FIG. 24 illustrates a flowchart of a method implemented at a network device according to some example embodiments of the present disclosure;

FIG. 25 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the wireless communication system, the DCI may be used by the network device to indicate the TCI-related information to the terminal device. In 3GPP release 15, TCI field is introduced in DCI format for PDSCH, which is either 0 bit (not present) or 3 bits, depending on radio resource control (RRC) configuration. In 3GPP release 16, it is supported that two TCI states can be mapped to one TCI field based on new MAC CE TCI state activation command, in order to support M-TRP.

In 3GPP release 17, the unified TCI framework is introduced to replace release 15/16 TCI state/spatial relation framework for beam indication. The indicated TCI is not only applied to PDSCH but also applied to other channels/signals. Further, in 3GPP release 17, only one unified TCI state can be mapped to one TCI codepoint in DCI. That is, in 3GPP releases 15 to 17, there is only one “TCI field” in DCI.

Further, in case of the unified TCI framework, the first joint TCI sate may correspond to the first TRP, and the second joint TCI state may correspond to the second TRP. When S-DCI based M-TRP operation is configured, support the followings:
For a serving cell configured with joint downlink (DL)/uplink (UL) TCI mode, a full-set or any sub-set of {first joint TCI state, second joint TCI state} can be mapped to a TCI codepoint of the existing TCI field in a DCI format 1_1/1_2 (with or without DL assignment);
   If the UE receives a TCI codepoint mapped with a full-set of {first joint TCI state, second joint TCI state}, the UE shall update the corresponding joint TCI states in the full-set;
   If the UE receives a TCI codepoint mapped with a sub-set of {first joint TCI state, second joint TCI state}, the UE shall update the corresponding joint TCI state in the sub-set, and keep current joint TCI state not in the sub-set; and
   TCI state activation command (MAC-CE) should indicate that each activated joint TCI state in the TCI state activation command is mapped to the first or second joint TCI state of a TCI codepoint, and how to indicate is up to RAN2 design.
For a serving cell configured with separate DL/UL TCI mode, the first DL and UL TCI sates correspond to the first TRP, the second DL and UL TCI states correspond to the second TRP, and a full-set or any sub-set of {first DL TCI state, first UL TCI state, second DL TCI state, second UL TCI state} may be mapped to a TCI codepoint of the existing TCI field in a DCI format 1_1/1_2 (with or without DL assignment).
   If the UE receives a TCI codepoint mapped with a full-set of {first DL TCI state, first UL TCI state, second DL TCI state, second UL TCI state}, the UE shall update the corresponding DL/UL TCI states in the full-set;
   If the UE receives a TCI codepoint mapped with a sub-set of {first DL TCI state, first UL TCI state, second DL TCI state, second UL TCI state}, the UE shall update the corresponding DL/UL TCI state(s) in the sub-set, and keep current DL/UL TCI state(s) not in the sub-set; and
   TCI state activation command (MAC-CE) should indicate that each activated DL/UL TCI state in the TCI state activation command is mapped to the first DL TCI state, first UL TCI state, second DL TCI state, or second UL TCI state of a TCI codepoint, and how to indicate is up to RAN2 design.

According to the currently-discussed of release 18, the unified TCI framework is extended to support M-TRP. Further, it has been agreed that in addition to continuing using the existing TCI field for TCI indication, a new field in DC which is used for PDSCH TCI state selection is agreed, and the new field is temporality named as TCI selection field for ease discussion the following descriptions.

It has been agreed that more than one TCI state may be indicated to the terminal device and the terminal device may select at least one TCT state for PDSCH. According to the agreements, information about the indicated TCI state(s) and information about TCI selection are indicated in different fields and further applied by the terminal device according to different timing control mechanism, which causes some scenarios where there are not TCI states for TCI selection or the terminal device is confused about which TCI states may be used for TCI selection.

In some embodiments, a 2-bit TCI selection field may be configured by RRC to be present in a DCI format 1_1/1_2 that schedules/activates PDSCH reception (including dynamic PDSCH and SPS PDSCH) according to the followings:
If the DCI format 1_1/1_2 indicates codepoint “00” for the TCI selection field, the UE shall apply the first one of two indicated joint/DL TCI states to all PDSCH demodulation reference signal (DMRS) port(s) of corresponding PDSCH transmission occasions(s) scheduled/activated by the DCI format 1_1/1_2;
If the DCI format 1_1/1_2 indicates codepoint “01” for the TCI selection field, the UE shall apply the second one of two indicated joint/DL TCI states to all PDSCH DMRS port(s) of corresponding PDSCH transmission occasions(s) scheduled/activated by the DCI format 1_1/1_2;
If the DCI format 1_1/1_2 indicates codepoint “10” for the TCI selection field, the UE shall apply both indicated joint/DL TCI states to the PDSCH reception scheduled/activated by the DCI format 1_1/1_2 according to the followings:
For PDSCH time division multiplexing (TDM)/space division multiplexing (SDM)/frequency division multiplexing (FDM) Tx schemes, release 16 mapping rules are reused to map the first and the second indicated joint/DL TCI states to PDSCH transmission occasions, code division multiplexing (CDM) groups, or non-overlapping frequency domain resource allocations by replacing the first and the second indicated legacy TCI states with the first and the second indicated joint/downlink (DL) TCI states;
For PDSCH-SFN Tx scheme, the UE shall apply both the first and the second indicated joint/DL TCI states to all PDSCH DMRS port(s) based on release 17 QCL type(s)/assumption(s) for PDSCH-single frequency network (SFN);
For PDSCH coherent joint transmission (CJT) Tx scheme, the UE shall apply both the first and the second indicated joint/DL TCI states to all PDSCH DMRS port(s).

According to some example embodiments discussed below, more interpretations about the TCI selection field, especially for the reserved value “11” of the TCI selection field will be discussed.

Further, whether to support two default beams (i.e., two TCI states) may be implemented as a UE capability. Further, it may be selectively to apply the above interpretations of TCI selection according to different scenarios. Specifically, if the UE is in frequency range 1 (FR1), or the UE supports the capability of two default beams for S-DCI based M-TRP in frequency range 2 (FR2) regardless of threshold, apply the above interpretations of TCI selection to PDSCH reception(s) scheduled/activated by the DCI format 1_1/1_2. Further, if the UE supports the capability of two default beams for S-DCI based M-TRP in FR2, UE uses both indicated joint/DL TCI states to buffer the received signal before a threshold.

Alternatively, if the UE doesn't support the capability of two default beams for S-DCI based M-TRP in FR2, apply the above interpretations of TCI selection to the scheduled/activated PDSCH reception when the offset between the reception of the scheduling DCI format 1_1/1_2 and the scheduled/activated PDSCH reception is equal to or larger than a threshold.

In the above embodiments, information about the indicated TCI state(s) and information about TCI selection are indicated in different fields. Further, according to legacy solutions, the UE apply the indicated TCI state(s) and TCI selection according to different timing control mechanism. In this event, at least due to the different timing control mechanism and the unclarity of about the relationship between the TCI selection field and the indicated states, there would be some scenarios where there are not TCI states for TCI selection or the terminal device is confused about which TCI states may be used for TCI selection. Thus, how to interpret the TCI configuration information such that the terminal device may select proper TCI state(s) is desirable to be discussed.

According to the present disclosure, the terminal device receives a first message comprising a first configuration indicating a selection of TCI state. The terminal device may determine a set of TCI states intended for the selection of TCI state based on at least one of a first relationship, a second relationship or a third relationship. In the present discourse, the first relationship refers to a relationship between a first reception time point of receiving the first configuration and a second reception time point of receiving a second configuration indicating at least one TCI state, the second relationship refers to a relationship between a first effective time point of the first configuration and a second effective time point of the second configuration, and the third relationship refers to a relationship between a first frequency resource associated with the first configuration and a second frequency resource associated with the second configuration.

By considering the above relationship(s), the terminal device may interpret the TCI configuration information and then select TCI state(s) properly.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “TRP” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner.

There may be no explicit TRP identification (ID). If multi-downlink control information (M-DCI) is assumed, the TRP ID may be implicitly identified via control resource set (CORESET) Pool Index (CORESETPoolIndex). If single-DCI (S-DCI) is assumed, the TRP ID may implicitly identified via sounding reference signal (SRS) resource set ID for uplink (UL) transmission at least. Therefore, the term “TRP” can be used interchangeably with the terms “CORESETPoolIndex” and SRS resource set.

In the case of M-DCI, a terminal device is configured by a higher layer parameter PDCCH-Config that contains two different values of CORESETPoolIndex in ControlResourceSet for the active bandwidth part (BWP) of a serving cell.

In the case of S-DCI, there is only one value of CORESETPoolIndex in ControlResourceSet.

As used herein, the terms “UE expects”, “UE does not expect, “terminal device expects”, “terminal device does not expect” may imply restrictions on a configuration of a network device (also referred to as NW configuration). The terms “UE is not expected to” and “terminal device is not expected to” may imply a terminal implementation, also referred to as UE implementation. In some embodiments, the terms “UE does not expect” and “UE is not expected to” may be used equally.

As used herein, the terms “transmission capability information”, “UE capability information”, “capability-related information”, “capability value set” may be used interchangeably.

As used herein, the terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “transmission configuration indication state (TCI state)”, “UL TCI state”, “joint TCI state”, “transmission configuration indicator”, “quasi co-location (QCL)”, “quasi-co-location”, “QCL parameter”, “QCL assumption”, “QCL relationship” and “spatial relation” can be used interchangeably.

As used herein, the terms “TRP”, “TCI state”, “TCI”, “CORESET”, “CORESET pool”, “UL TCI state”, “DL TCI state”, “joint TCI state”, “separate TCI state” may be used interchangeably.

As used herein, the terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “M-TRP” and “M-TCI”, “M-TRP” can be used interchangeably.

In the present discourse, a TCI state may refer to a joint TCI state, one or two separate TCI states, or a pair of separate TCI states. Similarly, two TCI states may refer to two joint TCI states, two or four separate TCI states, or two pairs of separate TCI states.

The term “BWP ID/index” can be used interchangeably with the terms “BWP/component carrier (CC) ID/index”, “CC identity/index”, “cell identity/index”, “physical cell identity/index”, “physical cell identity (PCI)”, “physCellId” and “serving cell identity/index”.

The term “codepoint” can be used interchangeably with the terms “code value”, “bitmap”, “bit value”, “field value” and “payload”.

Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.

In the following, although some embodiments are described with respect to two TCI states, these embodiments are only for the purpose of illustration and help those skilled in the art to understand and implement the present disclosure, without suggesting any limitations as to the scope of the present disclosure. In other embodiments, there may be more than two TCI states.

As for the TCI selection filed in DCI format 1_1/1_2, the TCI selection may be performed among two joint TCI states and two separate DL TCI states for the PDSCH transmissions. Similar, as for the SRS resource set indicator (SRI) field in DCI format 0_1/0_2, the TCI selection may be performed among two joint TCI states and two separate UL TCI states for the PUSCH transmissions. These two processes are similar. Merely for brevity, example embodiments are discussed by using TCI selection filed and PDSCH. However, such discussion may be adaptable for SRI field and PUSCH.

Principles and implementations of the present disclosure will be described in detail below with reference to the figures.

### Example Environment

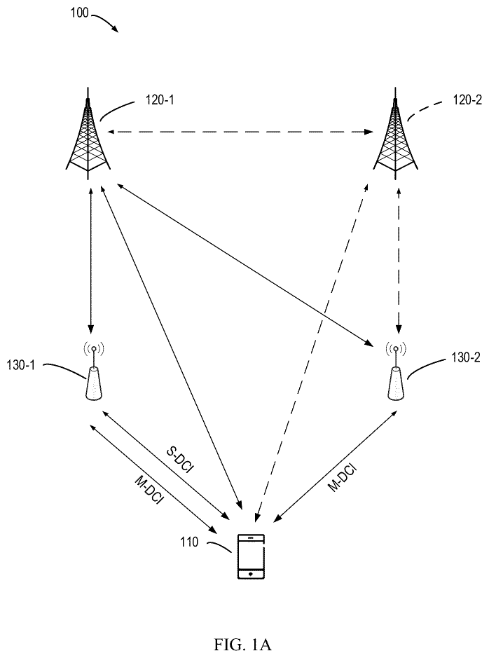

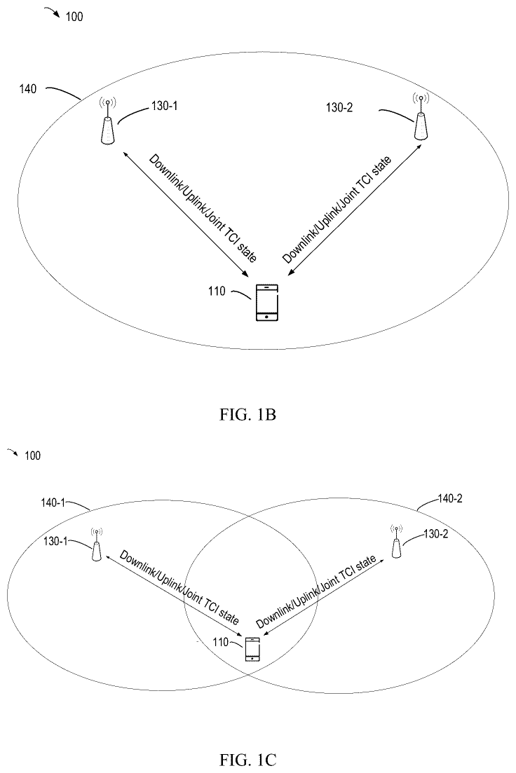

FIG. 1A illustrates an example communication network 100 in which embodiments of the present disclosure can be implemented. The communication network 100 includes a network device 120-1 and an optionally network device 120-2 (collectively or individually referred to as network devices 120). For purpose of discussion, the network device 120-1 is referred to as the first network device 120-1, and the network device 120-2 is referred to as the second network device 120-2. Further, the first network device 101-1 and the second network device 120-1 can communicate with each other. The network device 120 can provide services to a terminal device 110.

It is to be understood that the number of devices and their connections shown in FIG. 1A are only for the purpose of illustration without suggesting any limitation. The communication environment 100 may include any suitable number of devices configured to implementing example embodiments of the present disclosure. In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In the environment network 100, a link from the network devices 120 (such as, a first network device 120-1 or the second network device 120-2) to the terminal device 110 is referred to as a DL, while a link from the terminal device 110 to the network devices 120 (such as, a first network device 120-1 or the second network device 120-2) is referred to as an UL. In DL, the first network device 120-1 or the second network device 120-2 is a transmitting (TX) device (or a transmitter) and the terminal device 110 is a receiving (RX) device (or a receiver). In UL, the terminal device 110 is a transmitting TX device (or a transmitter) and the first network device 120-1 or the second network device 120-2 is a RX device (or a receiver).

In addition, in order to support multi-TRP and/or multi-panel, the network device 110 may be equipped with one or more TRPs. For example, the network device 110 may be coupled with multiple TRPs in different geographical locations to achieve better coverage. In one specific example embodiment, the first network device 120-1 is equipped with the first TRP 130-1 and the second TRP 130-2. Alternatively, in another specific example embodiment, the first network device 120-1 and the second network device 120-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP (also referred to as single TCI) mode transmission and multi-TRP (also referred to as multi-TCI) mode are supported by the specific example of FIG. 1A. Specifically, in case of the single TRP mode, the terminal device 110 communicates with the network via the first TRP 130-1/second TRP 130-2, and the transmission is performed based on the first/second control resource set pool and one TCI state accordingly.

Alternatively, in case of the multi-TRP mode, the terminal device 110 communicates with the network via both of the first TRP 130-1 and the second TRP 130-2, and the transmission is performed based on both of the first and second control resource set pools and two one TCI states accordingly.

Further, the network device(s) 120 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100 as shown in FIG. 1A. In the specific example of FIG. 1B, the first TRP 130-1 and the second TRP 130-2 are included in a same serving cell 140. In this event, the multi-TRP transmission is performed as an intra-cell transmission.

FIG. 1C shows another example scenario of the communication network 100 as shown in FIG. 1A. In the specific example of FIG. 1C, the first TRP 130-1 and the second TRP 130-2 are included in different serving cells 140-1 and 140-2. In this event, the multi-TRP transmission is performed as an inter-cell transmission.

Further, the unified TCI framework is supported in the communication network 100. In some embodiments, the multi-TRP/single TRP transmission may be scheduled by either a single DCI message or multiple DCI message (i.e., multi-DCI/M-DCI). Specifically, one or more pre-configured TCI states may be indicated by the single/multiple DCI messages.

As illustrated in FIG. 1A, when a single DCI mode is applied, the terminal device 110 receives a single DCI message from the first TRP 130-1. It should be understood that the single DCI message also may be received from the second TRP 130-2.

Alternatively, when a multi-DCI mode is applied, the terminal device 110 receives two DCI messages from the first TRP 130-1 and the second TRP 130-2, respectively.

In the specific example of FIG. 1A, the terminal device 110 may be configured with a list of up to M TCI-State configurations within the higher layer parameter PDSCH-Config to decode PDSCH according to a detected physical downlink control channel (PDCCH) with DCI intended for the UE and the given serving cell, where M depends on the UE capability maxNumberConfiguredTCIstatesPerCC. Each TCI State contains parameters for configuring a QCL relationship between one or two downlink reference signals and the DMRS ports of the physical downlink shared channel (PDSCH), the DMRS port of PDCCH or the channel state information-reference signal (CSI-RS) port(s) of a CSI-RS resource. The QCL relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The QCL types corresponding to each DL RS are given by the higher layer parameter qcl-Type in QCL-Info and may take one of the following values:
> ‘typeA’: {Doppler shift, Doppler spread, average delay, delay spread};
> ‘typeB’: {Doppler shift, Doppler spread};
‘typeC’: {Doppler shift, average delay};
‘typeD’: {Spatial Rx parameter}.

In some embodiments, the terminal device 110 may be configured with a list of up to 128 TCI-State configurations, within the higher layer parameter dl-OrJoint-TCIStateList in PDSCH-Config for providing an RS for the QCL for DMRS of PDSCH and DMRS of PDCCH in a bandwidth part (BWP)/component carrier (CC), for CSI-RS, and to provide a reference, if applicable, for determining UL TX spatial filter for dynamic-grant and configured-grant based PUSCH and PUCCH resource in a BWP/CC, and SRS.

If the TCI-State or UL-TCI-State configurations are absent in a BWP of the CC, the terminal device 110 may apply the TCI-State or UL-TCI-State configurations from a reference BWP of a reference CC. The terminal device 110 is not expected to be configured with tci-StatesToAddModList, Spatial RelationInfo or PUCCH-SpatialRelationInfo, except SpatialRelationInfoPos in a CC in a band, if the terminal device 110 is configured with dl-OrJoint-TCIStateList or UL-TCI-State in any CC in the same band. The terminal device 110 may assume that when the terminal device 110 is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the terminal device 110 is not configured with dl-OrJoint-TCIStateList or UL-TCI-State in any CC within the same band in the CC list.

The terminal device 110 receives an activation command, used to map up to 8 TCI states and/or pairs of TCI states, with one TCI state for DL channels/signals and/or one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the activation command maps TCI-State and/or UL-TCI-State to only one TCI codepoint, the terminal device 110 shall apply the indicated TCI-State and/or UL-TCI-State to one or to a set of CCs/DL BWPs, and if applicable, to one or to a set of CCs/UL BWPs once the indicated mapping for the one single TCI codepoint is applied.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the numbers of devices (i.e., the terminal device 110, the network device 110, the TRP 130 and the cell 140) and their connection relationships and types shown in FIGS. 1A to 1C are only for the purpose of illustration without suggesting any limitation. The communication network 100 may include any suitable numbers of devices adapted for implementing embodiments of the present disclosure.

### Example Processes

Further, it is to be understood that the operations at the terminal device 110 and the network device 120 should be coordinated. In other words, the network device 120 and the terminal device 110 should have common understanding about configurations, parameters and so on. Such common understanding may be implemented by any suitable interactions between the network device 120 and the terminal device 110 or both the network device 120 and the terminal device 110 applying the same rule/policy. In the following, although some operations are described from a perspective of the terminal device 110, it is to be understood that the corresponding operations should be performed by the network device 120. Similarly, although some operations are described from a perspective of the network device 120, it is to be understood that the corresponding operations should be performed by the terminal device 110. Merely for brevity, some of the same or similar contents are omitted here.

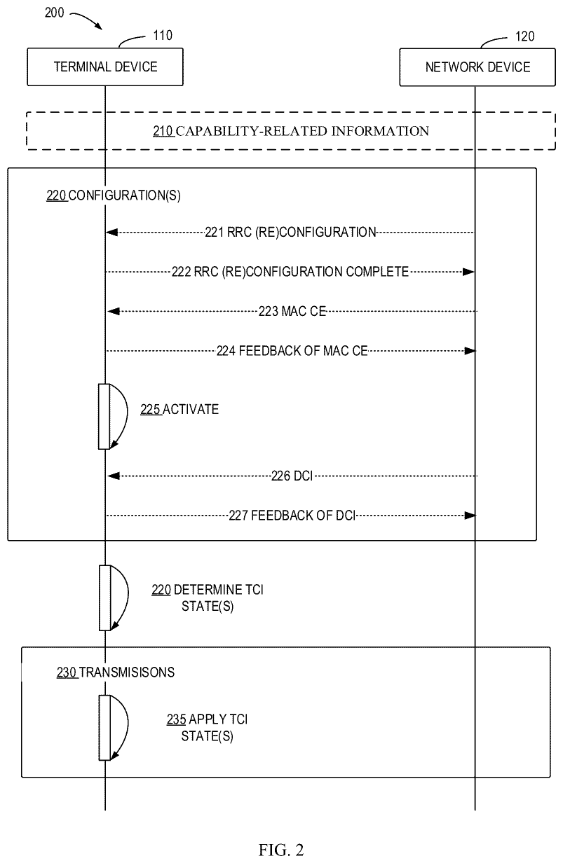

Reference is made to FIG. 2, which illustrates a signaling flow 200 of communication in accordance with some embodiments of the present disclosure. For the purposes of discussion, the signaling flow 200 will be discussed with reference to FIG. 1A, for example, by using the terminal device 110 and the network device 120.

In the specific example of FIG. 2, the terminal device 110 is originally applying a first set comprising a first TCI state and a second TCI state and receives a configuration information indicating a second set comprising a third TCI state to be used by the terminal device 110.

In operation, as illustrated FIG. 2, the terminal device 110 and the network device 120 may optionally exchange 210 capability-related information with each other.

In some embodiments, when a number of TCI states in the second set is smaller than a number of TCI states in the first set, how to update the TCI states may be implemented as a UE capability. In this event, the terminal device 110 may transmit capability-related information to the network device 120, where the capability-related information may indicate whether a capability of updating one of the first and second TCI states while continuing applying the other one of the first and second TCI states is supported by the terminal device 110. Alternatively, in some embodiments, the capability-related information may indicate that terminal device 110 only support updating to the single TCI state (i.e., applying the indicated TCI state only).

Further, the terminal device 110 may use default TCI state(s) in some cases, and the supported number of default TCI states also may be implemented as a UE capability. In this event, the terminal device 110 may transmit capability-related information to the network device 120, where the capability-related information may indicate whether the terminal device 110 may support more than one default TCI state, or indicate the maximum number of default TCI states supported by the terminal device 110.

It is to be understood that the above illustrated capability-related information is given for illustrative purpose only. It should be understood that any suitable capability-related information associated with the embodiments discussed herein may be communicated. The present disclosure is not limited in this regard.

As illustrated in FIG. 2, before performing 230 transmissions, the terminal device 110 and the network device 120 may exchange configuration(s) with each other. The configuration(s) may be comprised one or more messages/signalling, including RRC signalling, MAC CE or DCI. In one example embodiment, the network device 120 transmits 221 an RRC (Re) configuration signalling to the terminal device 110 and the terminal device 110 110 may transmit 222 an RRC (Re) configuration complete signalling as a response. Alternatively, or in addition, in another example embodiment, the network device 120 transmits 223 a MAC CE to the terminal device 110 and the terminal device 110 110 may transmit 224 feedback of MAC CE to the network device 120, such as, hybrid automatic repeat request-acknowledgement (HARQ-ACK) of the MAC CE. Alternatively, or in addition, in another example embodiment, the network device 120 transmits 226 a DCI to the terminal device 110 and the terminal device 110 110 may transmit 227 feedback of DCI to the network device 120, such as, HARQ-ACK of the DCI.

Merely for better understanding, a general procedure for configurating TCI state is described with reference to FIG. 2. First, the RRC signalling may configure a plurality of TCI states for the terminal device 110, and then part of the plurality of TCI states may be activated 225 by the received MAC CE. In the following, one or more activated TCI states may be indicated by the DCI message and the terminal device 110 may apply 235 the indicated TCI states (or select one or more TCI states from the indicated TCI states and apply the selected TCI state(s)).

It is to be clarified that in some scenarios, the following DCI is not necessary and may be omitted accordingly. Some example scenarios are discussed as below.

In some embodiments, if there is only one TCI state activated by the MAC CE, the following DCI may be omitted. The terminal device 110 may apply the activated TCI states.

Alternatively, in some embodiments, if there are only two TCI states activated by the MAC CE, the following DCI may be omitted. The terminal device 110 may apply the activated TCI states.

Alternatively, in some embodiments, if there are only two pairs of DL TCI state and UL TCI state activated by the MAC CE, the following DCI may be omitted. The terminal device 110 may apply the activated TCI states.

Alternatively, in some embodiments, if there are only one/two DL TCI states and one/two UL TCI states activated by the MAC CE, the following DCI may be omitted. The terminal device 110 may apply the activated TCI states.

It is also to be clarified that in some scenarios, both the following MAC CE and DCI are not necessary and may be omitted accordingly. Some example scenarios are discussed as below.

In some embodiments, if there is only one TCI state configured by the RRC signalling, the following DCI may be omitted. The terminal device 110 may apply the configured TCI states.

Alternatively, in some embodiments, if there are only two TCI states configured by the RRC signalling, both the following MAC CE and DCI may be omitted. The terminal device 110 may apply the configured TCI states.

Alternatively, in some embodiments, if there are only two pairs of DL TCI state and UL TCI state configured by the RRC signalling, both the following MAC CE and DCI may be omitted. The terminal device 110 may apply the configured TCI states.

Alternatively, in some embodiments, if there are only one/two DL TCI states and one/two UL TCI states configured by the RRC signalling, both the following MAC CE and DCI may be omitted. The terminal device 110 may apply the configured TCI states.

As one example initial state, the terminal device 110 is applying a first TCI state and a second TCI state, and receives a configuration information indicates a third TCI state to be used by the terminal device 110. According to some embodiments of the present discourse, by using the configuration(s) and/or pre-defined rule(s), the terminal device 110 may determine first information and second information, where the first information indicates which one of the first and second TCI states is to be updated by the third TCI state, and second information indicates whether to continue applying the other one of the first and second TCI states or indicating whether to apply the third TCI state only.

Based on the first information and/or second information, the terminal device 110 may determine at least one TCI state to be used for the following transmissions. In one example embodiment, the terminal device 110 applies the second and third TCI states. Alternatively, in another example embodiment, the terminal device 110 applies the first and third TCI states. Alternatively, in a further example embodiment, the terminal device 110 applies the third TCI state only.

In some embodiments, the first and second information is indicated by the network device 120, either separately or jointly. Additionally, the first and/or second information may be indicated in at least one of the following: a TCI field in DCI, a TCI selection field in DCI, a TCI state activation field in MAC CE, or an information element (IE) in an RRC signalling.

As one specific embodiment, the “TCI field” in DCI indicates S-TCI (or S-TRP) when only one TCI state is mapped to the codepoint of TCI field. According to some embodiments of the present discourse, the “first information” and/or “second information” may be obtained by the terminal device via the “TCI selection field”, which is also used for TCI state selection for PDSCH. Below table 1 illustrates five different UE assumptions on applied TCI states for PDSCH.

TABLE 1
five different UE assumptions on applied TCI states for PDSCH
Before update: {TCI state ID x1/the first TCI state,
TCI state ID x2/the second TCI state};
“TCI field” provide TCI state ID y1 or TCI state ID y2;
After update: Applied TCI state(s) at the terminal device

Applied TCI state(s) at the terminal device

| | | |
|---|---|---|
| 1 | TCI state ID y1 | TCI state ID y2 |
| 2 | TCI state ID y1 | TCI state ID x2 |

| | |
|---|---|
| 3 | TCI state ID y1 |

| | | |
|---|---|---|
| 4 | TCI state ID x1 | TCI state ID y2 |

| | |
|---|---|
| 5 | TCI state ID y2 |

In this way, the terminal device 110 may determine proper TCI state(s) for the following transmissions, especially for the scenario where only one TCI state is mapped to one codepoint of TCI field in DCI. Further, dynamic switching between S-TCI mode and M-TCI mode may be enabled in a low-overhead manner.

In the following, some example configurations about how to indicate the first and second information will be described.

In some embodiments, at least one of the first and second information is indicated by a codepoint in a TCI field. Specifically,
a first value of the codepoint indicates that the first TCI state is to be updated with the third TCI state and the second TCI state continues to be applied;
a second value of the codepoint indicates that the second TCI state is to be updated with the third TCI state and the first TCI state continues to be applied; or
a third value of the codepoint indicates only the third TCI state is to be applied.

As discussed above, the capability of updating one of the first and second TCI states while continuing applying the other one of the first and second TCI states may be not supported by the terminal device 110. In this event, if the number of TCI states in the second set is one, the terminal device 110 only apply the third TCI state. As a result, related codepoints are not supported.

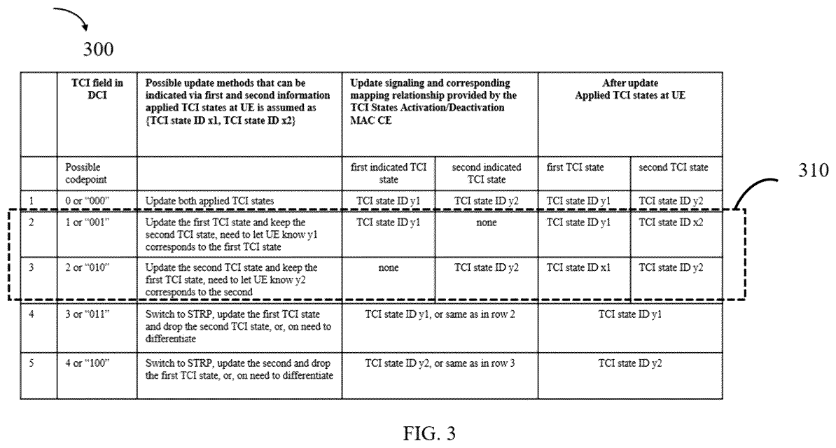

Merely for better understanding, reference is now made to FIG. 3, which illustrates an example block 300 for TCI selection.

In some embodiments, M-TRP schemes may be configured via RRC. Further, in the specific example of FIG. 3, the terminal device 110 is applying TCI states of {TCI state ID x1, TCI state ID x2}, where TCI state ID x1 is denoted as the first TCI state and TCI state ID x2 is denoted as the second TCI state.

As illustrated in FIG. 3, the first and second information is indicated by TCI field in DCI, i.e., different codepoints denote different update methods. The terminal device 110 may determine how to update the first TCI state and the second TCI state depending on the signaling content of the MAC CE and the codepoint of the TCI field.

As illustrated in FIG. 3, at least five different update methods may be indicated by five different codepoints. In particular, different codepoints are used to indicate “update to single TCI state” (codepoints #4 and #5) and “update a subset of TCI states” (i.e., continue applying the other one of the first and second TCI states, codepoints #2 and #3).

Further, as discussed previously, whether the terminal device 110 can support updating one of TCI states and maintaining the other one could be based on UE capability reporting. If the terminal device 110 does not support such capability, when one TCI state is mapped to one TCI codepoint, it means that S-TRP or S-TCI mode is enabled and the terminal device 110 could only apply the indicated TCI state for PDSCH reception. In this event, codepoints #2 and #3 in the dashed box 310 are not supported.

Alternatively, in some embodiments, at least one of the first and second information is indicated by a TCI state activation field in a MAC CE. Specifically, the TCI state activation field comprises:
at least one codepoint indicating at least one third TCI state,
at least one first parameter used for indicating the first information corresponding to the at least one third TCI state, and
at least one second parameter used for indicating the second information corresponding to the at least one third TCI state.

Additionally, in some embodiments, each of the at least one third TCI state is indicated by a bit string of an identity of the third TCI state, and the most significant bit of the bit string is used for indicating either the first information or the second information for the third TCI state.

In some embodiments, the MAC CE is identified by a MAC PDU subheader with eLCID, which has a variable size.

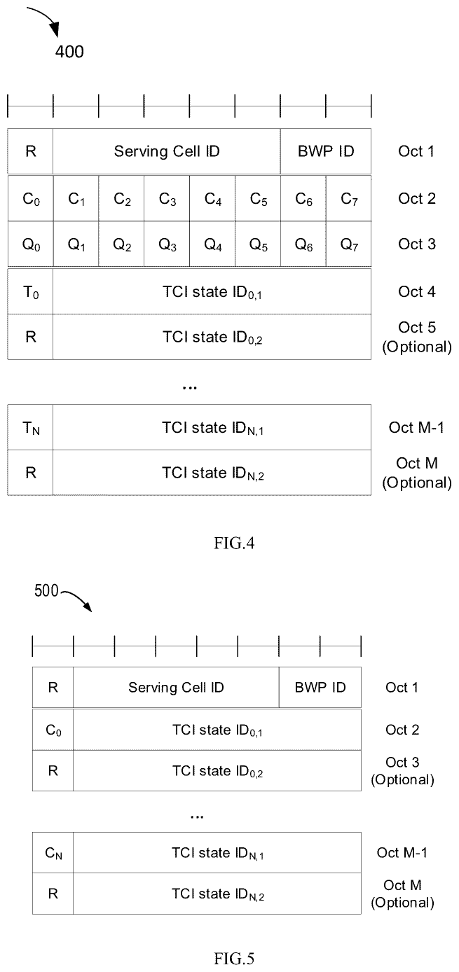

Merely for better understanding, reference is now made to FIGS. 4 to 6, which illustrates example structures 400 to 600 of MAC CE.

As illustrated in FIG. 4, fields of Serving Cell ID, BWP ID, Cᵢ and so on are comprised, where,
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2, this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field. The length of the BWP ID field is 2 bits;
Cᵢ: This field indicates whether the octet containing TCI state ID_{i,2} is present. If this field is set to 1, the octet containing TCI state ID_{i,2} is present. If this field is set to 0, the octet containing TCI state ID_{i,2} is not present;
TCI state ID_{i,j}: This field indicates the TCI state identified by TCI-StateId, where i is the index of the codepoint of the DCI Transmission configuration indication field and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2;
R: Reserved bit, set to 0.

In the specific example of FIG. 4, the first information may be indicated by using field Qi as below.
Qᵢ: This field indicates which TCI state for the i^{th} codepoint in the DCI TCI field is to be updated. If this field is set to 1, the octet containing TCI state ID_{i,1} is used to update the first TCI state for the i^{th} codepoint in the DCI TCI field. The octet containing TCI state ID_{i,1} is used to update the second TCI state for the i^{th} codepoint in the DCI TCI field; if Cᵢ is set to 1, Qᵢ can be ignored, and both TCI states can be updated.

Further, in the specific example of FIG. 4, the second information may be indicated by using field Tᵢ as below.
Tᵢ: This field indicates whether to switch to single TCI state for the i^{th} codepoint in the DCI TCI field. If this field is set to 1, the octet containing TCI state ID_{i,1} is used the i^{th} codepoint in the DCI TCI field. If this field is set to 0, the octet containing TCI state ID_{i,1} is used to update the first or second TCI state for the i^{th} codepoint in the DCI TCI field; if Cᵢ is set to 1, Tᵢ can be ignored.

It is to be understood that the above first and second information may be indicated jointly or separately in the illustrated MAC CE of FIG. 4 or may be indicated jointly or separately via RRC signalling.

Alternatively to the FIG. 4, instead of using Qᵢ and Tᵢ, the first and second information may be indicated by re-defining Cᵢ as illustrated in FIG. 5, where,
Cᵢ: This field indicates whether the octet containing TCI state ID_{i,2} is present. If this field is set to 1, the octet containing TCI state ID_{i,2} is present. If this field is set to 0, the N-bit (e.g., 2-bit) MSB or LSB of octet containing TCI state ID_{i,2} is used for indication of which TCI state for the codepoint (e.g., the first TCI state or the second TCI state) is to be updated by the indicated TCI state and/or whether to maintain the other TCI state, or to switch to S-TCI.

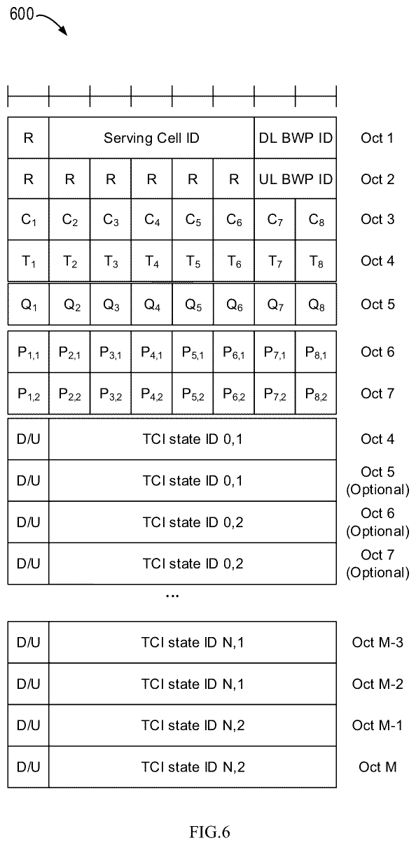

Further, as discussed above, in addition to the joint TCI state, the terminal device 110 also may be indicated with separate TCI states. FIG. 6 illustrates example structure 600 of MAC CE for separate TCI states. In the specific example of FIG. 6, the TCI state activation MAC CE provides information:
First information: Which TCI state for the codepoint (e.g., the first, the second, the third and the fourth TCI states) is to be updated by the indicated TCI state. In some examples, it suggests which TCI state for the codepoint (e.g., the first DL TCI state, the first UL TCI state, the first t pair of DL/UL TCI states, the second DL TCI state, the second UL TCI state, the second pair of DL/UL TCI states) is to be updated by the indicated TCI state;
   Qᵢ: This field indicates which TCI state for the i^{th} codepoint in the DCI TCI field is to be updated. If this field is set to 1, the octet containing TCI state ID_{i,1} is used to update the first DL TCI state, the first UL TCI state, or the first pair of DL/UL TCI states for the i^{th} codepoint in the DCI TCI field. the octet containing TCI state ID_{i,1} is used to update the second DL TCI state, the second UL TCI state, the second pair of DL/UL TCI states for the i^{th} codepoint in the DCI TCI field; if Cᵢ is set to 1, Qᵢ can be ignored;
Second information: When less than 4 TCI state IDs is mapped to one codepoint of TCI field in DCI, whether to maintain the other TCI state;
   Tᵢ: This field indicates whether to keep other TCI states for the i^{th} codepoint in the DCI TCI field. If this field is set to 1, TCI state ID_{i,1} and TCI state ID_{i,2} (if any) are used for the i^{th} codepoint in the DCI TCI field (not maintain). If this field is set to 0, TCI state ID_{i,1} and TCI state ID_{i,2} (if any) are used to update the first DL TCI state, the first UL TCI state, the first pair of DL/UL TCI states, the second DL TCI state, the second UL TCI state, 2nd pair of DL/UL TCI states for the i^{th} codepoint in the DCI TCI field;
Cᵢ: This field indicates whether the octets containing TCI state ID_{i,2} is present. If this field is set to 1, the octets containing TCI state ID_{i,2} is present. If this field is set to 0, the octets containing TCI state ID_{i,2} is not present;
P_{i,j}: This field indicates for TCI state ID_{i,j} corresponds to one or two TCI state IDs. If P_{i,j} field is set to 1, it indicates that TCI state ID_{i,j} corresponds to a pair of the DL TCI state and the UL TCI state. If P_{i,j} field is set to 0, it indicates that TCI state ID_{i,j} corresponds to only the DL/joint TCI state or the UL TCI state; If Cᵢ is set to 0, P_{i,2} can be ignored;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId. If D/U is set to 1, 7-bits length TCI state ID i.e. TCI-StateId is used. If D/U is set to 0, the most significant bit of TCI state ID is used as First information or Second information (switch to S-TRP UL or update the corresponding TCI state in indicated TCI states applied) and remainder 6 bits indicate the UL-TCIState-Id.

Alternatively, in some embodiments, at least one of the first and second information is jointly indicated by: a TCI field in DCI, and one of a TCI selection field in the DCI and an IE in an RRC signalling.

Additionally, in some embodiments, a reserved value of the TCI selection field (such as “11”) is used for indicating the second information. In some embodiments,
a first value of the codepoint in the TCI field and a reserved value of the TCI selection field jointly indicate that the first TCI state is to be updated with the third TCI state and the second TCI state continues to be applied; or
a second value of the codepoint in the TCI field and the reserved value of the TCI selection field jointly indicate that the second TCI state is to be updated with the third TCI state and the first TCI state continues to be applied.

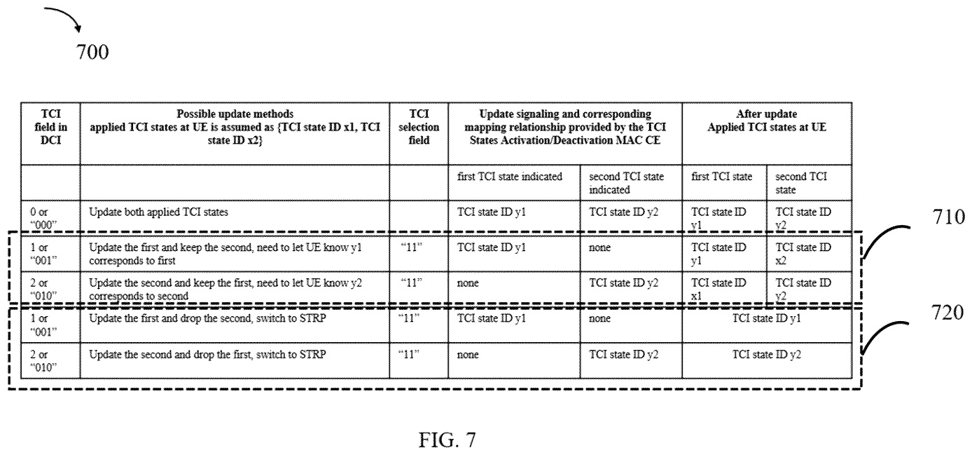

In some embodiments, since value “11” of TCI selection field has been reserved, value “11” may be used to indicate the terminal device 110 to keep M-TRP mode if only one TCI state is mapped to one codepoint of TCI field in DCI. Merely for better understanding, reference is now made to FIG. 7, which illustrates another example block 700 for TCI selection. In FIG. 7, rows in the dashed block 710 corresponding to the example where the reserved value “11” used for indicating continuing applying the other one of the first and second TCI states.

Additionally, if the terminal device 110 does not support the capability of updating one of the first and second TCI states while continuing applying the other one, if one TCI state is mapped to one TCI codepoint, it means that S-TRP or S-TCI mode is enabled. If so, the terminal device 110 may only apply the indicated TCI state for PDSCH reception. In this event, rows in the dashed box 710 would be not supported.

Alternatively, in some embodiments,
a first value of the codepoint in the TCI field and a reserved value of the TCI selection field jointly indicate that the first TCI state is to be updated with the third TCI state or only the third TCI state is to be applied; or
a second value of the codepoint in the TCI field and the reserved value of the TCI selection field jointly indicate that the second TCI state is to be updated with the third TCI state or only the third TCI state is to be applied.

Merely for better understanding, reference is now made to FIG. 7, which illustrates another example block 700 for TCI selection. In FIG. 7, rows in the dashed block 720 corresponding to the example where the reserved value “11” used for indicating applying the third TCI state only. In one embodiment, since value “11” of TCI selection field has been reserved, value “11” may be used to indicate the terminal device 110 to update the TCI state to a single TRP mode if only one TCI state is mapped to one codepoint of TCI field in DCI. In this way, some codepoint of TCI field may be saved for other TCI pairs or other purposes. Alternatively, or in addition, other TCI selection codepoint can be used for such S-TRP indication too, e.g.,
“10”, when only one TCI state is indicated, original intention of “10” to apply both TCI states may not be able to realized, then it can be used;
“01”, when only TCI state ID y1 is indicated to update the first TCI state;
“00”, when only TCI state ID y2 is indicated to update the second TCI state.

Alternatively, the TCI selection field or the IE in the RRC signalling is used for indicating the first information. Specifically,
a first value of a codepoint in the TCI field and a second value of either the TCI selection field or the IE jointly indicates that the first TCI state is to be updated with the third TCI state and the second TCI state continues to be applied; or
a third value of the codepoint in the TCI field and a fourth value of either the TCI selection field or the IE jointly indicates that the second TCI state is updated with the third TCI state and the third TCI state continues to be applied.

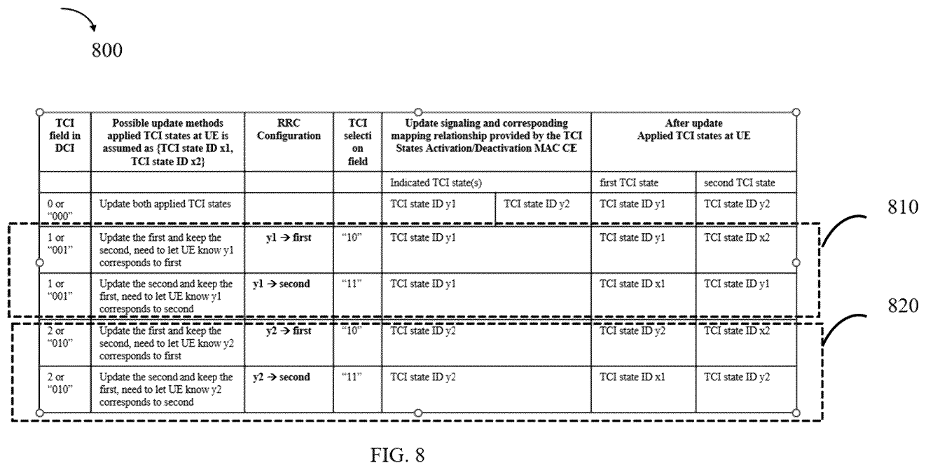

Merely for better understanding, reference is now made to FIG. 8, which illustrates another example block 800 for TCI selection. In FIG. 8, rows in the dashed block 810/820 corresponding to the example where the TCI selection field or the IE in the RRC signalling is used for indicating the first information.

In the specific embodiment of FIG. 8, the RRC may be used to indicate which TCI state for the codepoint (the first TCI state or the second TCI state) is to be updated by the indicated TCI state. Alternatively, values of “10” and “11” of the TCI selection field may be used to indicate which TCI state for the codepoint (the first TCI state or the second TCI state) is to be updated by the indicated TCI state. In some embodiments, legacy MAC CE design may be reused; alternatively, MAC CE design as discussed with reference to FIGS. 4-6 also may be applied, where either field of Pᵢ or Tᵢ may be added.

The TCI selection field is defined for TCI selection for PDSCH. Therefore, for DCI without DL assignment (no PDSCH scheduled), “TCI selection field” is not useful. In view of this, “TCI selection field” shall not be present in DCI without DL assignment. Such rule may be determined by default, pre-defined, or by RRC configuration.

Alternatively, if the above rule is not stipulated, the terminal device 110 may receive a configuration information comprising a TCI selection field while without comprising a downlink assignment (for example, receiving a configuration information used for updating TCI state only). However, as there is no downlink assignment, the terminal device 110 does not need to select TCI state and the information indicated by the TCI selection field is unnecessary. According to the embodiments of the present disclosure, the terminal device 110 may ignore the TCI selection field even if it is configured. As one specific embodiments, if the DCI format 1_1/1_2/is without DL assignment, the terminal device 110 can assume the following:
“TCI selection field” is ignored;
CS-RNTI is used to scramble the CRC for the DCI;
The values of the following DCI fields are set as follows:
   RV=all ‘1’s;
   MCS=all ‘1’s;
   NDI=0;
   Set to all ‘0’s for FDRA Type 0, or all ‘1’s for FDRA Type 1, or all ‘0’s for dynamicSwitch.

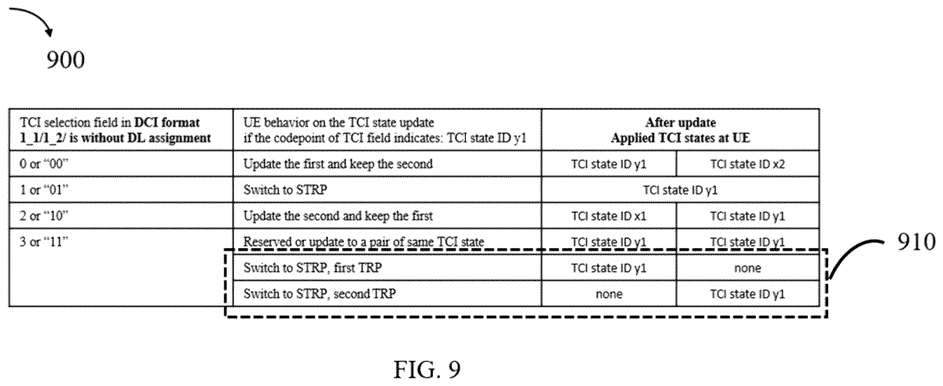

Alternatively, the TCI selection field may be used for indicating the first and second information. Merely for better understanding, reference is now made to FIG. 9, which illustrates another example block 900 for TCI selection. In the specific example of FIG. 9, the TCI selection field is used for indicating the first and second information, as illustrated by the rows in the dashed box 910.

Alternatively, according to some examples of the present disclosure, in addition to the TCI selection information, the TCI selection field may be used to indicate other information, including but not limited to, a mapping order of the first TCI state and the second TCI state, a QCL type, a layer combination, whether the latest TCI selection is to be kept, CDM grouping, time-domain behavior, reference TCI state for PDSCH CJT or PDSCH SFN, or whether the TCI selection field is a one-time configuration.

In some embodiments, one of the first and second value is “10”, and the other one of the first and second value is “11”.

In one specific embodiment, the first value indicates a first mapping order between the first and the second TCI states. Accordingly, the second value indicates a different mapping order between first and the second TCI states, compared to the mapping order indicated by the first value. The mapping order may be one of the following: order of {first, second}, order of {second, first}, a cyclic mapping, a sequential mapping.

In another specific embodiment, the first value indicates a first QCL type. Accordingly, the second value indicates a different QCL type, compared to QCL type indicated by the first value. Example QCL type may be one of the following: QCL type A, QCL type B, QCL type C, QCL type D, QCL parameters {Doppler shift, Doppler spread}, QCL parameters other than {Doppler shift, Doppler spread}.

In a further specific embodiment, the first value indicates a first layer combination. Accordingly, the second value indicates a different layer combination, compared to the layer combination indicated by the first value. Examples of the may be one of the following: 1+2, 2+1, or a first CDM grouping, e.g., in the same CDM group, in different CDM groups.

In a further specific embodiment, the first value indicates keeping the latest selection unchanged. In the other words, the first value indicates the selection is applied till next TCI selection field codepoint other than the first value. Accordingly, the second value indicates the selection is applied only for one-time, e.g., only for the scheduled PDSCH by the same DCI containing this TCI selection field.

In a further specific embodiment, the first value indicates the selection is applied only for one-time, e.g., only for the scheduled PDSCH by the same DCI containing this TCI selection field. Accordingly, the second value indicates keeping the latest selection unchanged. In the other words, the first value indicates the selection is applied till next TCI selection field codepoint other than the first value.

Additionally, in some embodiments, in case of a downlink transmission with a coherent joint transmission (CJT) type or a single frequency network (SFN) type, a first value of the TCI selection field indicates that the first TCI state is used as a reference TCI state and a second value of the TCI selection field indicates that the second TCI state is used as a reference TCI state.

In some embodiments, in case of a CJT type, a first value of the TCI selection field indicates that the first TCI state provides information for QCL type A and the second TCI state provides information for {Doppler shift, Doppler spread}, and a second value of the TCI selection field indicates that the second TCI state provides information for QCL type A and the first TCI state provides information for {Doppler shift, Doppler spread}.

Alternatively, in some embodiments, in case of an SFN type, a first value of the TCI selection field indicates that the first TCI state provides information for QCL type A and the second TCI state provides information for QCL parameters as QCL type A but excluding {Doppler shift, Doppler spread}, and a second value of the TCI selection field indicates that the second TCI state provides information for QCL type A and the first TCI state provides information for QCL parameters as QCL type A but excluding {Doppler shift, Doppler spread}.

The above description are mainly about the configuration(s) for the terminal device 110. In the following text, example processes about how to determine the set of TCI states intended for the selection of TCI state and how to apply the TCI states will be discussed.

According to some example embodiments of the present disclosure, the terminal device 110 receives a first message (such as, DCI) comprising a first configuration indicating a selection of TCI state. The terminal device 110 may determine a set of TCI states intended for the selection of TCI state based on at least one of a first relationship, a second relationship or a third relationship. In the present discourse, the first relationship refers to a relationship between a first reception time point of receiving the first configuration and a second reception time point of receiving a second configuration indicating at least one TCI state, the second relationship refers to a relationship between a first effective time point of the first configuration and a second effective time point of the second configuration, and the third relationship refers to a relationship between a first frequency resource associated with the first configuration and a second frequency resource associated with the second configuration.

Additionally, when the DCI/PDCCH reception includes two PDCCH candidates from two respective search space sets, for the purpose of determining the last symbol of the PDCCH, the PDCCH candidate that ends later in time is used. In other words, the time point of the last symbol of the PDCCH candidate that ends later is used as the reception time point of DCI/PDCCH.

By considering the above relationship(s), the terminal device 110 may interpret the TCI configuration information and select proper TCI state(s) accordingly.

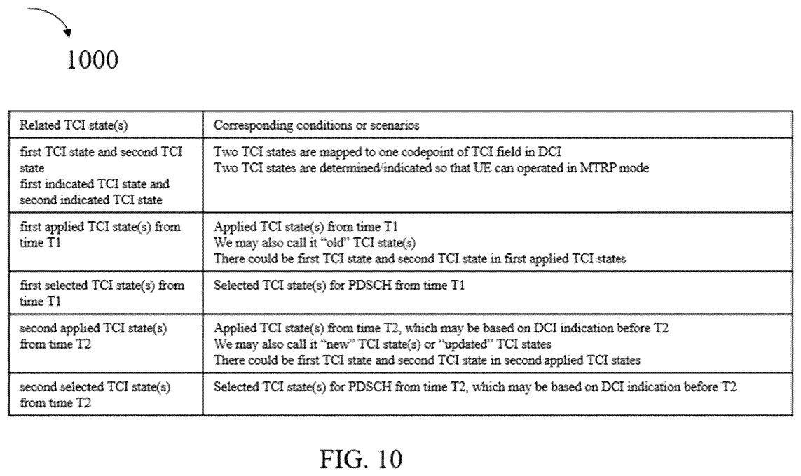

In actual communications, the terminal device 110 may be configured one or more TCI states, while the terminal device 110 may select and apply one or more TCI states. Reference is now made to FIG. 10, which illustrates an example mapping 1000 between different TCI state(s) and corresponding scenarios.

In some example embodiments, the second configuration is comprised in the (same) first message or a (different) second message, and the second message is received prior to or after the first message.

Additionally, if the second configuration is absent, the set of TCI states is determined based on one of the following: at least one TCI state being applied prior to the first reception time point, or at least one TCI state to be applied after the first reception time point.

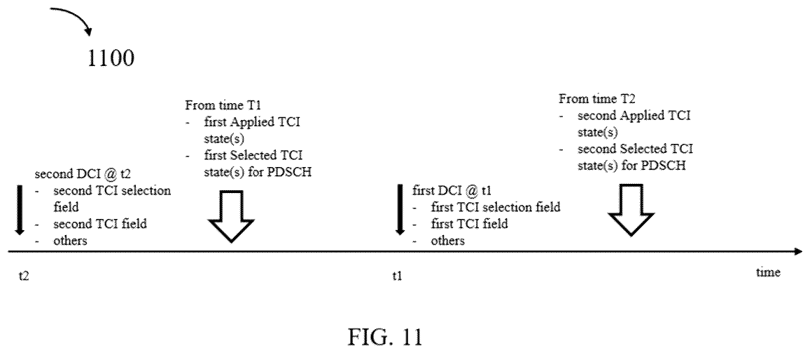

For better understanding, example processes will be described with references to FIGS. 11 to 17B.

In the specific example of FIG. 11, the TCI selection field and TCI field are comprised in the same message (the first DCI/the second DCI), and the terminal device 110 receives the second DCI at time point t2 and receives the first DCI at time point t1. As for the TCI selection field comprised in the first DCI, the set of TCI states intended for the selection of TCI state is one of the following:
the at least one TCI state indicated by the second configuration, the second configuration being comprised in the same first message. That is, the terminal device 110 selects the TCI state(s) from the indicated TCI states indicated by the TCI field in the same DCI, e.g., the first TCI field in the first DCI, as illustrated in FIG. 11;
the at least one TCI state indicated by the second configuration, the second configuration being comprised in the different second message received prior to the first message. That is, the terminal device 110 selects the TCI state(s) from the indicated TCI states indicated via the TCI field in the previous/latest DCI, e.g., the second TCI field in the second DCI, as illustrated in FIG. 11.

By selecting the TCI state(s) from the indicated TCI state(s), the set of TCI states intended for the selection of TCI state may be well determined by the terminal device 110 according to the receiving/effective timing of the TCI selection field and TCI field.

Alternatively, in the specific example of FIG. 11, the set of TCI states intended for the selection of TCI state is one of the following:
at least one TCI state being applied prior to the first reception time point. That is, the terminal device 110 selects the TCI state(s) from the applied TCI states, which are applied prior to the reception of the first DCI, e.g., the first applied TCI states, as illustrated in FIG. 11.
at least one TCI state to be applied after the first reception time point. That is, the terminal device 110 selects the TCI state(s) from the applied TCI states, which will be applied after the reception of the first DCI, e.g., the second applied TCI states, as illustrated in FIG. 11.

By selecting the TCI state(s) from the applied TCI state(s), even the TCI field is absent in the DCI message, the terminal device 110 still may determine the set of TCI states intended for the selection of TCI state.

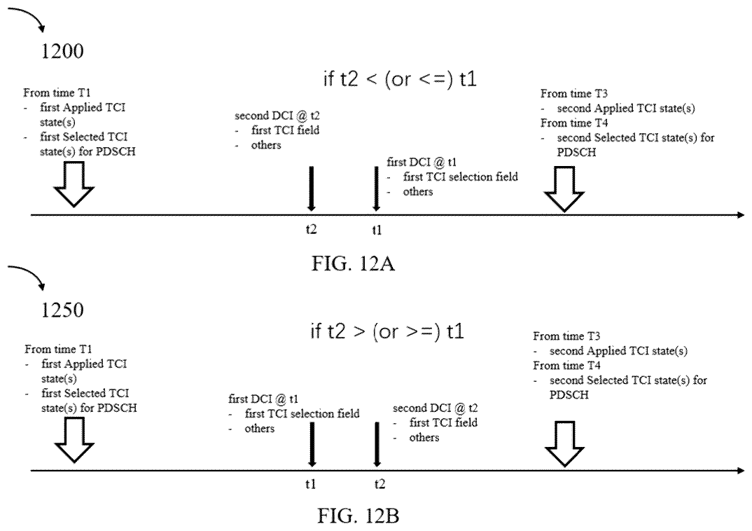

In the specific example of FIGS. 12A and 12B, the TCI selection field and TCI field are comprised in different messages, respectively (i.e., TCI selection field is comprised in the first DCI and the TCI filed is comprised in the second DCI). In FIG. 12A, the first DCI comprising the TCI selection field is received at time point t1, and the second DCI comprising the TCI field is received at time point t2 earlier than the time point t1. As for the TCI selection field comprised in the first DCI, the set of TCI states intended for the selection of TCI state is one of the following:
the at least one TCI state indicated by the second configuration, the second configuration being comprised in the different second message received prior to the first message. That is, the terminal device 110 selects the TCI state(s) from the indicated TCI states indicated via the TCI field in the previous/latest DCI, e.g., the second TCI field in the second DCI, as illustrated in FIG. 12A. In the other words, after receiving the second DCI, the terminal device 110 update TCI states based on the second DCI, and then after receiving the first DCI, select the TCI state(s) from the applied TCI states;
at least one TCI state being applied prior to the first reception time point t1. That is, the terminal device 110 selects the TCI state(s) from the applied TCI states, which are applied prior to the reception of the first DCI, e.g., the first applied TCI states, as illustrated in FIG. 12A.

In FIG. 12B, the first DCI comprising the TCI selection field is received at time point t1, and the second DCI comprising the TCI field is received at time point t2 after the time point t1. As for the TCI selection field comprised in the first DCI, the set of TCI states intended for the selection of TCI state is one of the following:
the at least one TCI state indicated by the second configuration, the second configuration being comprised in the different second message received after the first message. That is, the terminal device 110 selects the TCI state(s) from the indicated TCI states indicated via the TCI field in the next DCI carrying TCI field, e.g., the second TCI field in the second DCI, as illustrated in FIG. 12B. In the other words, the terminal device performs operations of selecting and updating sequentially, or performing among the to-be-updated TCI states in near future;
at least one TCI state being applied prior to the first reception time point t1. That is, the terminal device 110 selects the TCI state(s) from the applied TCI states, which are applied prior to the reception of the first DCI, e.g., the first applied TCI states, as illustrated in FIG. 12B.

In some embodiments, if the TCI selection field is received at time point t1, the first effective time point of the TCI selection field is determined to be t1+TimeDurationQCL. Further, “t1+TimeDurationQCL” may refer to the first time unit (such as, the first slot) after a duration of “t1+TimeDurationQCL”.

According to some embodiments of the present disclosure, during [t1, t1+TimeDurationQCL], the terminal device110 needs to decode DCI, and adjust its Rx parameters as indicated, in this duration, the terminal device110 may not be able to use the selected TCI state as indicated, therefore a default selection may apply.

In some embodiments, if the DCI further contains CSI trigger information, the effective time point of TCI selection filed for CSI-RS may be determined to be the first time unit (such as, the first slot) after a duration of t1+beamSwitchTiming, where a value of the beamSwitch Timing is reported by the terminal device 110.

In some embodiments, beam switching timing delay ‘d’ is needed if SCS of DCI/PDCCH is smaller than the SCS of CSI-RS.

Additionally, as for the TimeDurationQCL, sub-carrier space (SCS) may be defined as below:
scs-60 kHz: {s7, s14, s28};
scs-120 KHz: {s14, s28};
scs-60 kHz: {s56, s112};
scs-120 KHz: {s112, s224}.

The time unit of the SCS is symbol, i.e., s7 means 7 symbols.

Accordingly, if the TCI field is received at time point t2, the second effective time point of the TCI selection field is determined to be t2+N+beamAppTime, where ‘N’ refers to time duration between the DCI and a PUCCH with HARQ-ACK information or a PUSCH with HARQ-ACK information corresponding to the DCI, or corresponding to the PDSCH scheduled by the DCI, if the indicated TCI State(s) is different from the previously indicated TCI state(s).

Further, “t2+N+beamAppTime” may refer to the first time unit (such as, the first slot) after a duration of “t2+N+beamAppTime”.

According to some embodiments of the present disclosure, before t2+N+beamAppTime, the terminal device110 may not be able to use the TCI states as indicated, therefore default TCI states (such as, the applied TCI states) may be used.

Additionally, as for the beamAppTime may be defined to be n1, n2, n4, n7, n14, n28, n42, n56, n70, n84, n98, n112, n224, n336, wherein the time unit is symbol and the reference SCS for determining the SCS duration is the smallest SCS of the active BWP of all CCs in the same CC list.

In some embodiments, as the TCI selection field and/or the TCI field has not been effected, default selection of TCI state and/or default TCI states may be applied. According to some embodiments of the present disclosure, when “default selection of TCI state” is considered, the terminal device 110 may ignore the “TCI selection field” and apply the default selection of TCI state rule. Similarly, when “indicated selection of TCI state” is considered, “TCI selection field” may be interpreted in any suitable manner as described in this disclosure.

In the present disclosure, the default selection of TCI state may be one of the following:
a selection of TCI state configured by a radio resource control (RRC) signalling, for example, selecting the first TCI state, the second TCI state, both of the first and the second TCI states, none of the first and the second TCI states;
selecting the first TCI state if a number of the set of TCI state is larger than one;
selecting two TCI states if the set of TCI states comprise at least two TCI states;
selecting a TCI state that is applied to reception with the first configuration (i.e., PDCCH reception with the scheduling/activation DCI);
selecting the at least one TCI state indicated by the second configuration, or
selecting at least TCI state as the latest applied selection of TCI state.

In the present disclosure, the default TCI states are one of the following:
a set of TCI states each of which is configured with a lower or higher identity,
a set of TCI states corresponding to a set of codepoints, each of the set of codepoints is configured with a lower or higher index,
at least one latest TCI state,
quasi-co-location (QCL) assumption determined during an initial random access or a latest random access,
QCL assumption for receiving scheduling information of downlink transmissions, or
QCL assumption of at least one associated control resource set (CORESET).

In some embodiments, the terminal device 110 may expect the same effective time point for TCI field and TCI selection field.

Alternatively, or in addition, in some embodiments, the terminal device 110 may expect the same reception time point and the same effective time point for TCI field and TCI selection field.

In some embodiments, the terminal device 110 may expect the network device 120 to provide configurations to make sure that t1+TimeDurationQCL=t2+N+beamAppTime.

In some embodiments, the terminal device 110 may determine the effective time point is the later one of the first and the second effective time points, e.g., max (t1+TimeDurationQCL, t2+N+beamAppTime).

In some embodiments, if the first effective time point is earlier than the second effective time point, at least one of the following is performed:
prior to the first effective time point, a default selection of TCI state is performed among default TCI states;
during the first effective time point and the second effective time point, the selection of TCI state indicated by the first configuration is performed among the default TCI states; and
after the second effective time point, the selection of TCI state indicated by the first configuration is performed among the at least one TCI state indicated by the second configuration.

Alternatively, if the second effective time point is earlier than the first effective time point, at least one of the following is performed:
prior to the second effective time point, a default selection of TCI state is performed among default TCI states;
during the second effective time point and the first effective time point, the default selection of TCI state is performed among the at least one TCI state indicated by the second configuration, and
after the first effective time point, the selection of TCI state indicated by the first configuration is performed among the at least one TCI state indicated by the second configuration.

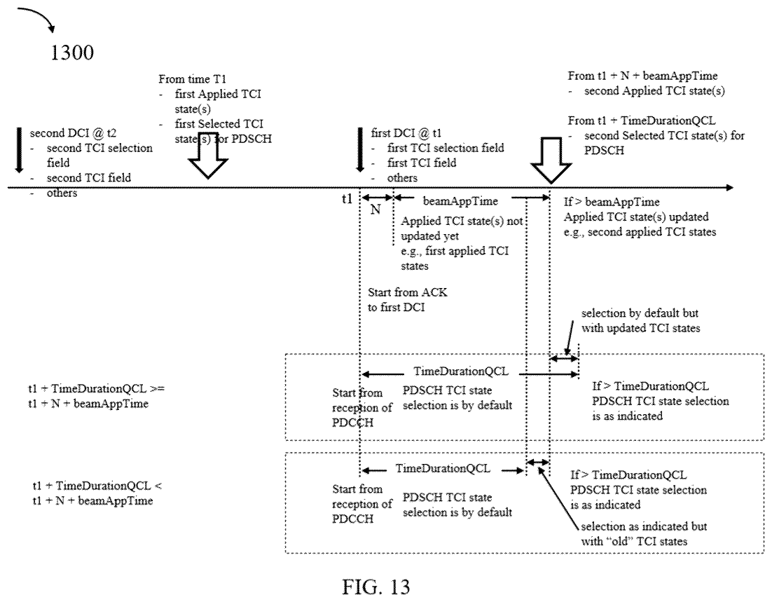

In the specific example of FIG. 13, the TCI selection field and TCI field are comprised in the same message (i.e., the first DCI) at time point t1. In this specific embodiment of FIG. 13, if t1+TimeDurationQCL>=t1+N+beamAppTime (i.e., TimeDurationQCL>=N+beamAppTime),
Before t1+N+beamAppTime: default selection of TCI state is performed among default TCI states (such as, the first applied TCI states in FIG. 13);
Between t1+N+beamAppTime and t1+TimeDurationQCL: the default selection of TCI state is performed among the at least one TCI state indicated by the second configuration (i.e., the second applied TCI states);
After t1+TimeDurationQCL: the selection of TCI state indicated by the first configuration (i.e., indicated selection) is performed among the at least one TCI state indicated by the second configuration (i.e., the second applied TCI states).

Alternatively, if t1+TimeDurationQCL<t1+N+beamAppTime (i.e., TimeDurationQCL<N+beamAppTime),
Before t1+TimeDurationQCL: default selection of TCI state is performed among default TCI states (such as, the first applied TCI states in FIG. 13);
Between t1+TimeDurationQCL and t1+N+beamAppTime: the selection of TCI state indicated by the first configuration (i.e., indicated selection) is performed among the default TCI states (such as, the first applied TCI states in FIG. 13);
After t1+N+beamAppTime: the selection of TCI state indicated by the first configuration (i.e., indicated selection) is performed among the at least one TCI state indicated by the second configuration (i.e., the second applied TCI states).

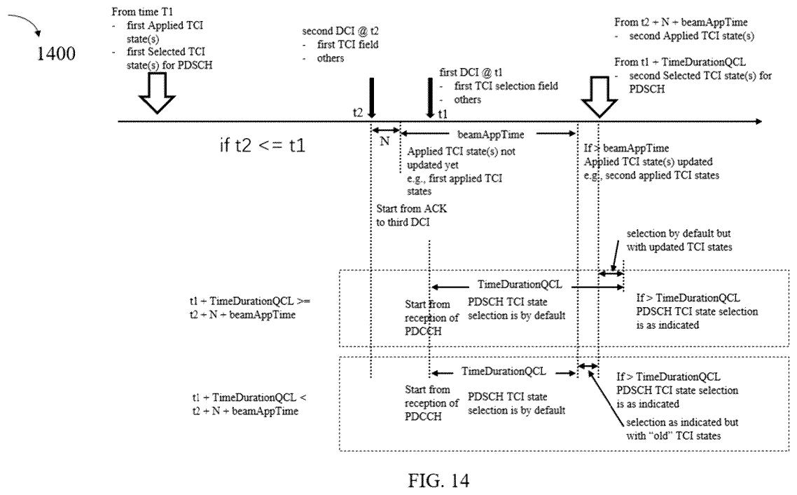

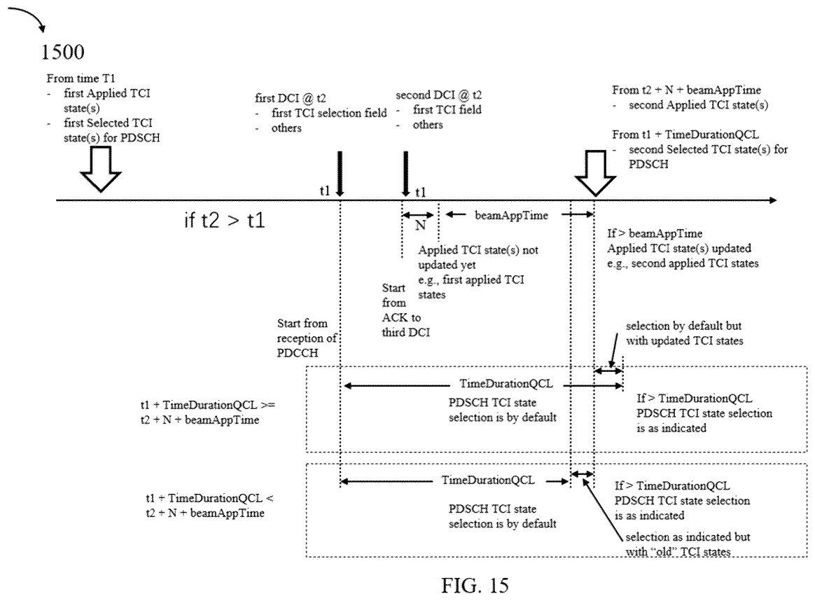

In the specific examples of FIGS. 14 and 15, the TCI selection field is comprised in the first DCI received at time point t1, and TCI field are comprised in the second DCI received at time point t2 earlier than or after the time point t1. In these specific embodiments of FIGS. 14 and 15, if t1+TimeDurationQCL>=t2+N+beamAppTime,
Before t2+N+beamAppTime: default selection of TCI state is performed among default TCI states;
Between t2+N+beamAppTime and t1+TimeDurationQCL: the default selection of TCI state is performed among the at least one TCI state indicated by the second configuration (i.e., the second applied TCI states);
After t1+TimeDurationQCL: the selection of TCI state indicated by the first configuration (i.e., indicated selection) is performed among the at least one TCI state indicated by the second configuration (i.e., the second applied TCI states);

Alternatively, if t1+TimeDurationQCL<t2+N+beamAppTime,
Before t1+TimeDurationQCL: the selection of TCI state indicated by the first configuration (i.e., indicated selection) is performed among the default TCI states;
Between t1+TimeDurationQCL and t2+N+beamAppTime: indicated selection, the first applied TCI states;
After t2+N+beamAppTime: the default selection of TCI state is performed among the at least one TCI state indicated by the second configuration (i.e., the second applied TCI states).

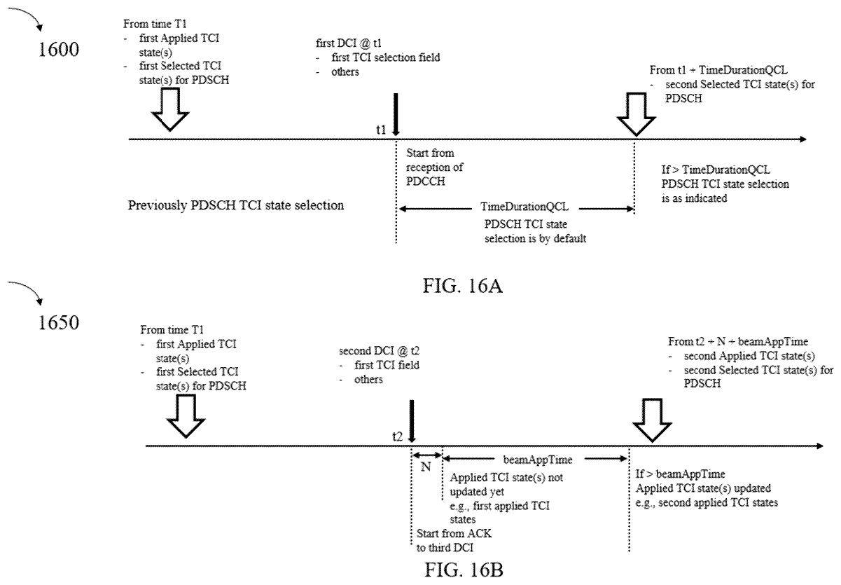

In some cases, the second configuration may be absent. If so, prior to the first effective time point, a default selection of TCI state is performed, and after the first effective time point, the selection of TCI state indicated by the first configuration is performed. An example timing 1600 for TCI selection is illustrated in FIG. 16A.

Alternatively, the first configuration may be absent. If so, prior to the second effective time point, default TCI states is applied, and after the second effective time point, the at least one TCI state indicated by the second configuration is applied. An example timing 1650 for TCI selection is illustrated in FIG. 16B.

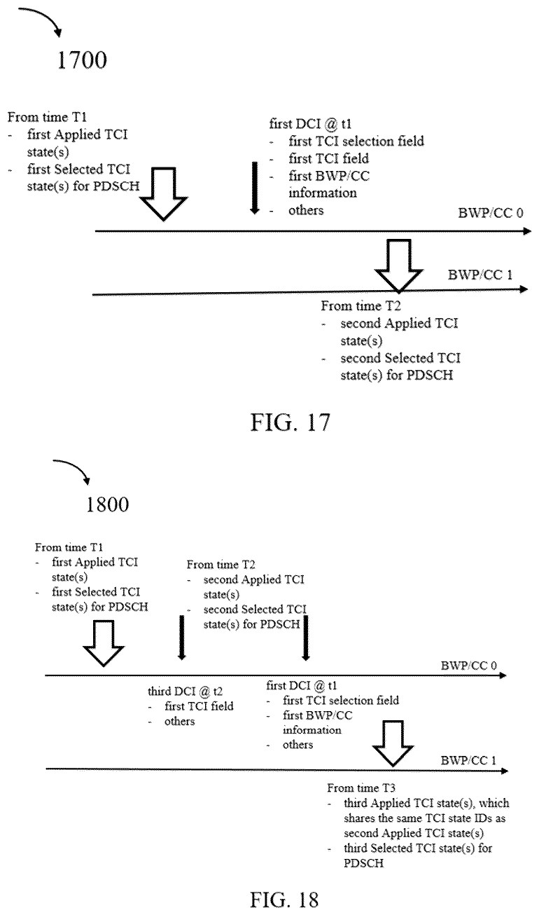

In some embodiments, if the first and second frequency resources belong to a same bandwidth part (BWP)/component carrier (CC) list, the first message further indicates information about the first frequency resource, the selection of TCI state is performed based on a plurality of TCI states associated with the first frequency resource. Example timings for TCI selection are illustrated in FIGS. 17 and 18.

In the specific embodiments of FIG. 17, the TCI field in DCI in the scheduling BWP/CC points to the activated TCI states in the scheduled BWP/CC (e.g., the second BWP/CC, BWP/CC 1), and TCI selection field is based on indicated TCI states on the second BWP/CC. In the specific embodiments of FIG. 18, the TCI field in DCI in the scheduling BWP/CC points to the activated TCI states on the first BWP/CC (e.g., BWP/CC 0) and TCI selection field is based on indicated TCI states on the second BWP/CC.

Alternatively, in some embodiments, if the first and second frequency resources belong to different BWP/CC lists, the first message further indicates information about the first frequency resource, and the terminal device may activate a plurality of TCI states associated with the first frequency resource; and prior to a completion of the activation, default TCI states is applied. Further, if the terminal device 110 does not support two default TCI states, the TCI selection field may be ignored.

Additionally, in some embodiments, for beamAppTime, to determine symbol duration, the first reference SCS is the smallest SCS of the active BWP of all CCs in the same CC list; for timeDurationForQCL, to determine symbol duration, the second reference SCS is the SCS of the active BWP/CC that TCI states applied. In some other embodiments, we may need to align the SCS for both beamAppTime and timeDurationForQCL, it can be either first or second SCS, or maximum of the two, or minimum of the two.

Generally speaking, in order to perform selection of TCI state, the terminal device 110 needs to determine at least two TCI states. However, in some cases, the terminal device 110 fails to determine at least two TCI states if:
a number of TCI states configured by a radio resource control (RRC) signalling is one. That is, RRC only configures one TCI state;
TCI states configured by an RRC have not been activated by MAC CE. That is, RRC has configured a list of TCI states but no MAC CE activation has been received yet;
a MAC CE only maps one TCI state for one TCI codepoint,
a number of TCI states activated by a MAC CE is one,
the second configuration is absent, such as, “TCI field” is not present in DCI;
the at least one TCI state indicated by the second configuration has not been activated (or has not been known to the terminal device 110), or
the at least one TCI state indicated by the second configuration is associated with a BWP/CC list (or cell) different from a BWP/CC list (or cell) associated with the first configuration.

According to some embodiments of the present disclosure, if a number of the set of TCI states intended for the selection of TCI state is less than two, at least one of the following may be performed:
ignoring the first configuration; That is, it is considered as an error case, and the terminal device is not expected to perform anything under such scenario;
not expecting to receive the first configuration; That is, when TCI selection field is present in DCI, only consider TCI codepoints that are mapped with two TCI states. In this way, the number of codepoints in TCI field can be smaller than the number of TCI codepoints that are activated by the activation command.
expecting all the codepoints are mapped with two TCI states;
applying the set of TCI states;
applying at least one default TCI state; or
performing the selection of TCI state on default TCI states, if the terminal device could support two default TCI states.

The above discussions are especially for PDSCH reception. It should be understood that the above key concept also may be applied for other channels/signals, for example, PDCCH, CORESET, PUCCH, PUSCH, SRS, CSI-RS, because the other channels/signals also need to select proper TCI state(s).

Below table 2 illustrates correspondences between the other channels/signals (which may replace the PSDCH) and information about TCI state selection (which May replace the TCI selection field).

TABLE 2
example correspondences

| | information about TCI state selection (including |
|---|---|
| channels/signals | explicit indication and predefined rule) |
| PDCCH | RRC configuration per CORESET |
| PDSCH scheduled/activated by | Predefined rule, e.g., apply the first UE is not configured |
| DCI format 1_0 | with sfnSchemePdsch, apply both first and second the UE |
| | is configured with sfnSchemePdsch |
| PUSCH scheduled/activated by | An indicator field in DCI format 0_1/0_2, e.g., SRS |
| DCI format 0_1/0_2 (including | resource set indicator |
| DG-PUSCH and Type2 CG- | |
| PUSCH) | |
| PUSCH scheduled/activated by | apply the first indicated |
| DCI format 0_0 | |
| Type1 CG-PUSCH | RRC configuration per CG |
| PUCCH | RRC configuration per PUCCH resource/resource group |
| AP CSI-RS for CSI/BM | An RRC configuration is provided in CSI- |
| | AssociatedReportConfigInfo of CSI- |
| | AperiodicTriggerState |
| | for enhanced group-based beam reporting or NCJT CSI |
| | measurement, a fixed rule |
| SRS for CB/NCB | An RRC configuration per resource or resource set |
| SRS for antenna switching | An RRC configuration per resource or resource set |
| AP SRS for BM | An RRC configuration per resource or resource set |

By using the above correspondences in table, the above described embodiments may be adaptable for the other channels/signals. Especially, for the other channels/signals, if a number of the set of TCI states intended for the selection of TCI state is less than two, at least one of the following may be performed:
ignoring the first configuration; That is, it is considered as an error case, and the terminal device is not expected to perform anything under such scenario;
not expecting to receive the first configuration; That is, when TCI selection field is present in DCI, only consider TCI codepoints that are mapped with two TCI states. In this way, the number of codepoints in TCI field can be smaller than the number of TCI codepoints that are activated by the activation command.
applying the set of TCI states;
applying at least one default TCI state; or
performing the selection of TCI state on default TCI states, if the terminal device could support two default TCI states.

According to the above discussed example processes, the terminal device 110 may interpret the TCI-related configuration properly.

Additionally, as discussed above, the terminal device 110 needs to apply the default TCI state(s) and/or default selection of TCI state. The above descriptions have given some example scenarios where the default TCI state(s) and/or default selection is needed. Merely for brevity, the contents that have been discussed previously will not be discussed again. Some further descriptions are summarized as below.

In one embodiment, in case that information about TCI state selection is absent, default selection of TCI state is needed. Information about TCI state selection may refer to any information comprised in RRC signaling, MAC CE or DCI, such as illustrated in Table 2.

In another embodiment, in case that information about TCI state is absent, default of TCI state(s) is needed. Information about TCI state may refer to information comprised in RRC signaling, MAC CE or DCI. As one example, RRC configuration indicates that “TCI field” is not present. Alternatively, TCI field in the DCI is absent.

In a further embodiment, both information about TCI state selection and information about TCI state are absent.

In another embodiment, for PDSCH scheduled earlier than “timeDurationQCL” threshold, and for PDSCH scheduled earlier than “beamAppTime” threshold, default TCI state(s) and/or default selection of TCI state may be needed.

In summary, the default TCI state(s) and/or default selection of TCI state may be applied to any scenario where the terminal device fails to obtain information about TCI state selection and/or information about TCI state are present. The present discolors is not limited in this regard.

### Example Methods

FIG. 19 illustrates a flowchart of a communication method 1900 implemented at a terminal device in accordance with some embodiments of the present disclosure. For the purpose of discussion, the method 1900 will be described from the perspective of the terminal device 110 in FIG. 1A.

At block 1910, the terminal device receives, a first message comprising a first configuration indicating a selection of transmission configuration indicator (TCI) state.

At block 1920, the terminal device determines, a set of TCI states intended for the selection of TCI state based on at least one of the following: a first relationship between a first reception time point of receiving the first configuration and a second reception time point of receiving a second configuration indicating at least one TCI state, the second configuration being comprised in the first message or a second message, the second message being received prior to or after the first message, a second relationship between a first effective time point of the first configuration and a second effective time point of the second configuration, or a third relationship between a first frequency resource associated with the first configuration and a second frequency resource associated with the second configuration.

In some example embodiments, if the second configuration is absent, the set of TCI states is determined based on one of the following: at least one TCI state being applied prior to the first reception time point, or at least one TCI state to be applied after the first reception time point.

In some example embodiments, the set of TCI states intended for the selection of TCI state is one of the following: the at least one TCI state indicated by the second configuration, the second configuration being comprised in the first message, the at least one TCI state indicated by the second configuration, the second configuration being comprised in the different second message received prior to the first message, the at least one TCI state indicated by the second configuration, the second configuration being comprised in the different second message received after the first message, at least one TCI state being applied prior to the first reception time point, or at least one TCI state to be applied after the first reception time point.

In some example embodiments, if the first effective time point is earlier than the second effective time point, prior to the first effective time point, a default selection of TCI state is performed among default TCI states; during the first effective time point and the second effective time point, the selection of TCI state indicated by the first configuration is performed among the default TCI states; and after the second effective time point, the selection of TCI state indicated by the first configuration is performed among the at least one TCI state indicated by the second configuration.

In some example embodiments, if the second effective time point is earlier than the first effective time point, prior to the second effective time point, a default selection of TCI state is performed among default TCI states; during the second effective time point and the first effective time point, the default selection of TCI state is performed among the at least one TCI state indicated by the second configuration, and after the first effective time point, the selection of TCI state indicated by the first configuration is performed among the at least one TCI state indicated by the second configuration.

In some example embodiments, if the second configuration is absent, prior to the first effective time point, a default selection of TCI state is performed, and after the first effective time point, the selection of TCI state indicated by the first configuration is performed.

In some example embodiments, if the first configuration is absent, prior to the second effective time point, default TCI states is applied, and after the second effective time point, the at least one TCI state indicated by the second configuration is applied.

In some example embodiments, if the first and second frequency resources belong to a same bandwidth part (BWP)/component carrier (CC) list, the first message further indicates information about the first frequency resource, the selection of TCI state is performed based on a plurality of TCI states associated with the first frequency resource.

In some example embodiments, if the first and second frequency resources belong to different bandwidth part (BWP)/component carrier (CC) lists, the first message further indicates information about the first frequency resource, and the processor is further configured to cause the terminal device to: activate a plurality of TCI states associated with the first frequency resource; and prior to a completion of the activation, default TCI states is applied.

In some example embodiments, if a number of the set of TCI states is less than two, the processor is further configured to cause the terminal device to: ignore the first configuration; not expect to receive the first configuration; expect all the codepoints are mapped with two TCI states; apply the set of TCI states; apply at least one default TCI state; or perform the selection of TCI state on default TCI states.

In some example embodiments, the processor is further configured to cause the terminal device to: determine a number of the set of TCI states is less than two if at least one of the following: a number of TCI states configured by a radio resource control (RRC) signalling is one, TCI states configured by an RRC have not been activated by MAC CE, a MAC CE only maps one TCI state for one TCI codepoint, a number of TCI states activated by a MAC CE is one the second configuration is absent, the at least one TCI state indicated by the second configuration has not been activated, or the at least one TCI state indicated by the second configuration is associated with a bandwidth part (BWP)/component carrier (CC) list different from a BWP/CC list associated with the first configuration.

In some example embodiments, the default TCI states are one of the following: a set of TCI states each of which is configured with a lower or higher identity, a set of TCI states corresponding to a set of codepoints, each of the set of codepoints is configured with a lower or higher index, at least one latest TCI state, quasi-co-location (QCL) assumption determined during an initial random access or a latest random access, QCL assumption for receiving scheduling information of downlink transmissions, or QCL assumption of at least one associated control resource set (CORESET).

In some example embodiments, the default selection of TCI state is one of the following: a selection of TCI state configured by a radio resource control (RRC) signalling; selecting the first TCI state if a number of the set of TCI state is larger than one; selecting two TCI states if the set of TCI states comprise at least two TCI states; selecting a TCI state that is applied to reception with the first configuration; selecting the at least one TCI state indicated by the second configuration; or selecting at least TCI state as the latest applied selection of TCI state.

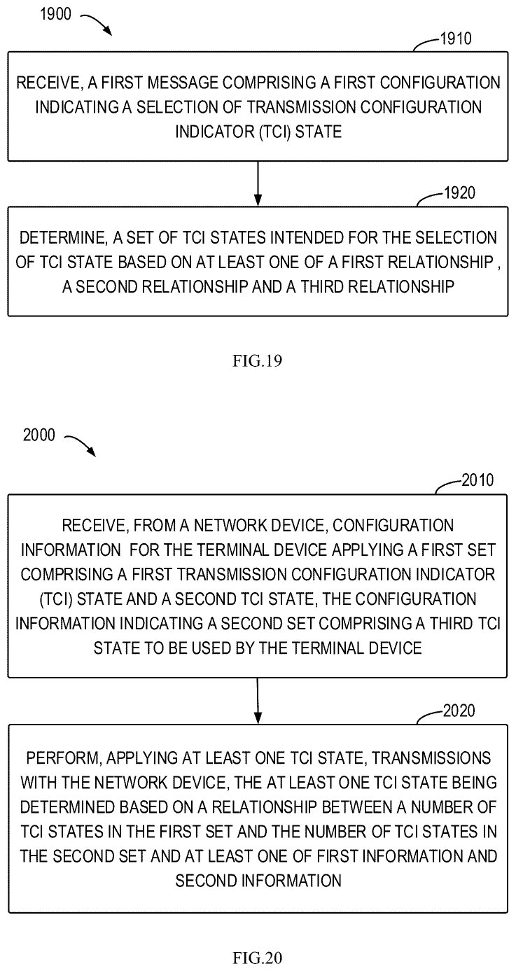

FIG. 20 illustrates a flowchart of a communication method 2000 implemented at a terminal device in accordance with some embodiments of the present disclosure. For the purpose of discussion, the method 2000 will be described from the perspective of the terminal device in FIG. 1A.

At block 2010, the terminal device receives, from a network device, configuration information for the terminal device applying a first set comprising a first transmission configuration indicator (TCI) state and a second TCI state, the configuration information indicating a second set comprising a third TCI state to be used by the terminal device.

At block 2020, the terminal device performs, by applying at least one TCI state, transmissions with the network device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In some example embodiments, any of the first, second, third TCI state is a joint TCI state, a separate TCI state or a pair of separate TCI states; and wherein, any of the at least one of the TCI state is a joint TCI state, a separate TCI state or a pair of separate TCI states.

In some example embodiments, applying the at least one TCI state comprising at least one of the following: applying the second and third TCI states, applying the first and third TCI states, or applying the third TCI state only.

In some example embodiments, the first and second information is indicated separately or jointly, and wherein at least one of the first and second information is indicated in at least one of the following: a TCI field in downlink control information (DCI), a TCI selection field in DCI, a TCI state activation field in medium access control (MAC) control element (CE), or an information element (IE) in a radio resource control (RRC) signalling.

In some example embodiments, at least one of the first and second information is indicated by a codepoint in a TCI field in downlink control information (DCI), and wherein, a first value of the codepoint indicates that the first TCI state is to be updated with the third TCI state and the second TCI state continues to be applied; a second value of the codepoint indicates that the second TCI state is to be updated with the third TCI state and the first TCI state continues to be applied; or a third value of the codepoint indicates only the third TCI state is to be applied.

In some example embodiments, at least one of the first and second information is indicated by a TCI state activation field in a medium access control (MAC) control element (CE), and wherein the TCI state activation field comprises: at least one codepoint indicating at least one third TCI state, at least one first parameter used for indicating the first information corresponding to the at least one third TCI state, and at least one second parameter used for indicating the second information corresponding to the at least one third TCI state.

In some example embodiments, each of the at least one third TCI state is indicated by a bit string of an identity of the third TCI state, and the most significant bit of the bit string is used for indicating either the first information or the second information for the third TCI state.

In some example embodiments, at least one of the first and second information is jointly indicated by: a TCI field in DCI, and one of a TCI selection field in the DCI and an information element (IE) in a radio resource control (RRC) signalling.

In some example embodiments, a reserved value of the TCI selection field is used for indicating the second information.

In some example embodiments, a first value of the codepoint in the TCI field and a reserved value of the TCI selection field jointly indicate that the first TCI state is to be updated with the third TCI state and the second TCI state continues to be applied; or a second value of the codepoint in the TCI field and the reserved value of the TCI selection field jointly indicate that the second TCI state is to be updated with the third TCI state and the first TCI state continues to be applied.

In some example embodiments, a first value of the codepoint in the TCI field and a reserved value of the TCI selection field jointly indicate that the first TCI state is to be updated with the third TCI state or only the third TCI state is to be applied; or a second value of the codepoint in the TCI field and the reserved value of the TCI selection field jointly indicate that the second TCI state is to be updated with the third TCI state or only the third TCI state is to be applied.

In some example embodiments, the TCI selection field or the IE in the RRC signalling is used for indicating the first information.

In some example embodiments, a first value of a codepoint in the TCI field and a second value of either the TCI selection field or the IE jointly indicates that the first TCI state is to be updated with the third TCI state and the second TCI state continues to be applied; or a third value of the codepoint in the TCI field and a fourth value of either the TCI selection field or the IE jointly indicates that the second TCI state is updated with the third TCI state and the third TCI state continues to be applied.

In some example embodiments, the processor is further configured to cause the terminal device to: transmit, to the network device, capability-related information indicating whether a capability of updating one of the first and second TCI states while continuing applying the other one of the first and second TCI states is supported by the terminal device.

In some example embodiments, the processor is further configured to cause the terminal device to: if the capability is not supported by the terminal device, in case that the number of TCI states in the second set is one, only apply the third TCI state.

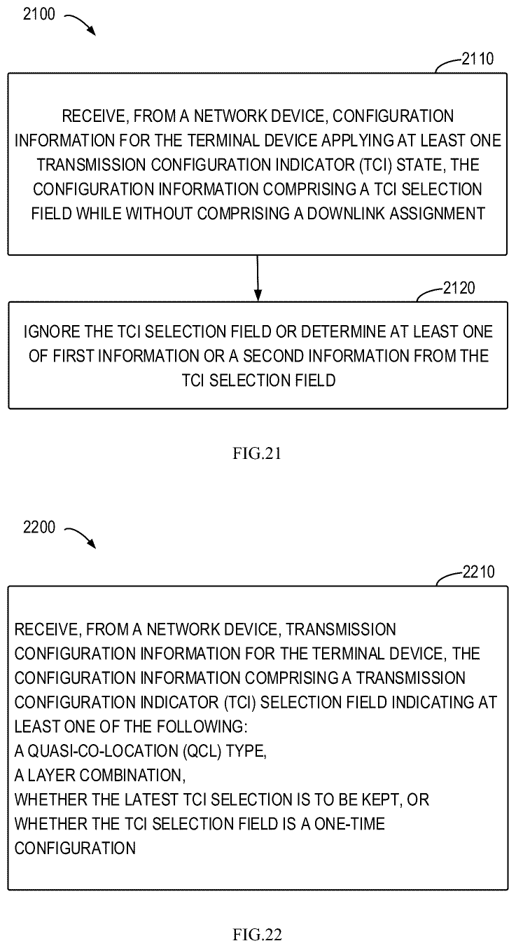

FIG. 21 illustrates a flowchart of a communication method 2100 implemented at a terminal device in accordance with some embodiments of the present disclosure. For the purpose of discussion, the method 2100 will be described from the perspective of the terminal device in FIG. 1A.

At block 2110, the terminal device receives, from a network device, configuration information for the terminal device applying at least one transmission configuration indicator (TCI) state, the configuration information comprising a TCI selection field while without comprising a downlink assignment.

At block 2120, the terminal device ignores the TCI selection field or determines at least one of first information or a second information from the TCI selection field, wherein, the first information indicates which one of the at least one TCI is to be updated, and the second information indicates whether to continue applying the other TCI state or only apply an indicated TCI state.

FIG. 22 illustrates a flowchart of a communication method 2200 implemented at a terminal device in accordance with some embodiments of the present disclosure. For the purpose of discussion, the method 2200 will be described from the perspective of the terminal device in FIG. 1A.

At block 2210, the terminal device receives, from a network device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In some example embodiments, the terminal device is applied with a first TCI state and a second device, or the configuration information indicates the first and second TCI states, and wherein, in case of a downlink transmission with a coherent joint transmission (CJT) type or a single frequency network (SFN) type, a first value of the TCI selection field indicates that the first TCI state is used as a reference TCI state and a second value of the TCI selection field indicates that the second TCI state is used as a reference TCI state.

In some example embodiments, the terminal device is applied with a first TCI state and a second device, or the configuration information indicates the first and second TCI states, and wherein, in case of a coherent joint transmission (CJT) type, a first value of the TCI selection field indicates that the first TCI state provides information for QCL type A and the second TCI state provides information for {Doppler shift, Doppler spread}, and a second value of the TCI selection field indicates that the second TCI state provides information for QCL type A and the first TCI state provides information for {Doppler shift, Doppler spread}.

In some example embodiments, the terminal device is applied with a first TCI state and a second device, or the configuration information indicates the first and second TCI states, and wherein, in case of a single frequency network (SFN) type, a first value of the TCI selection field indicates that the first TCI state provides information for QCL type A and the second TCI state provides information for QCL parameters excluding {Doppler shift, Doppler spread}, and a second value of the TCI selection field indicates that the second TCI state provides information for QCL type A and the first TCI state provides information for QCL parameters excluding {Doppler shift, Doppler spread}.

FIG. 23 illustrates a flowchart of a communication method 2300 implemented at a network device in accordance with some embodiments of the present disclosure. For the purpose of discussion, the method 2300 will be described from the perspective of the network device 120 in FIG. 1A.

At block 2310, the network device transmits, to a terminal device applying a first set comprising a first transmission configuration indicator (TCI) state and a second TCI state, configuration information for the terminal device, the configuration information indicating a second set comprising a third TCI state to be used by the terminal device.

At block 2320, the network device performs, based on at least one TCI state, transmissions with the terminal device, the at least one TCI state being determined based on a relationship between a number of TCI states in the first set and a number of TCI states in the second set and at least one of the following: At block 2340, first information indicating which one of the first and second TCI states is to be updated by the third TCI state, or second information indicating whether to continue applying the other one of the first and second TCI states or indicating whether to apply the third TCI state only.

In some example embodiments, any of the first, second, third TCI state is a joint TCI state, a separate TCI state or a pair of separate TCI states; and wherein, any of the at least one of the TCI state is a joint TCI state, a separate TCI state or a pair of separate TCI states.

In some example embodiments, the first and second information is indicated separately or jointly, and wherein at least one of the first and second information is indicated in at least one of the following: a TCI field in downlink control information (DCI), a TCI selection field in DCI, a TCI state activation field in medium access control (MAC) control element (CE), or an information element (IE) in a radio resource control (RRC) signalling.

In some example embodiments, at least one of the first and second information is indicated by a codepoint in a TCI field in downlink control information (DCI), and wherein, a first value of the codepoint indicates that the first TCI state is to be updated with the third TCI state and the second TCI state continues to be applied; a second value the codepoint indicates that the second TCI state is to be updated with the third TCI state and the first TCI state continues to be applied; a third value the codepoint indicates that only the third TCI state is to be applied.

In some example embodiments, at least one of the first and second information is indicated by a TCI state activation field in a medium access control (MAC) control element (CE), and wherein the TCI state activation field comprises: at least one codepoint indicating at least one third TCI state, at least one first parameter used for indicating the first information corresponding to the at least one third TCI state, and at least one second parameter used for indicating the second information corresponding to the at least one third TCI state.

In some example embodiments, each of the at least one third TCI state is indicated by a bit string of an identity of the third TCI state, and the most significant bit of the bit string is used for indicating either the first information or the second information for the third TCI state.

In some example embodiments, at least one of the first and second information is jointly indicated by: a TCI field in DCI, and one of a TCI selection field in the DCI and an information element (IE) in a radio resource control (RRC) signalling.

In some example embodiments, a reserved value of the TCI selection field is used for indicating the second information.

In some example embodiments, a first value of the codepoint in the TCI field and a reserved value of the TCI selection field jointly indicate that the first TCI state is to be updated with the third TCI state and the second TCI state continues to be applied; or a second value of the codepoint in the TCI field and the reserved value of the TCI selection field jointly indicate that the second TCI state is to be updated with the third TCI state and the first TCI state continues to be applied.

In some example embodiments, a first value of the codepoint in the TCI field and a reserved value of the TCI selection field jointly indicate that the first TCI state is to be updated with the third TCI state or only the third TCI state is to be applied; or a second value of the codepoint in the TCI field and the reserved value of the TCI selection field jointly indicate that the second TCI state is to be updated with the third TCI state or only the third TCI state is to be applied.

In some example embodiments, the TCI selection field or the IE in the RRC signalling is used for indicating the first information.

In some example embodiments, a first value of a codepoint in the TCI field and a second value of either the TCI selection field or the IE jointly indicates that the first TCI state is to be updated with the third TCI state and the second TCI state continues to be applied; or a third value of the codepoint in the TCI field and a fourth value of either the TCI selection field or the IE jointly indicates that the second TCI state is updated with the third TCI state and the third TCI state continues to be applied.

In some example embodiments, the terminal device transmits, to the network device, capability-related information indicating whether updating one of the first and second TCI states while continuing applying the other one of the first and second TCI states is supported by the terminal device.

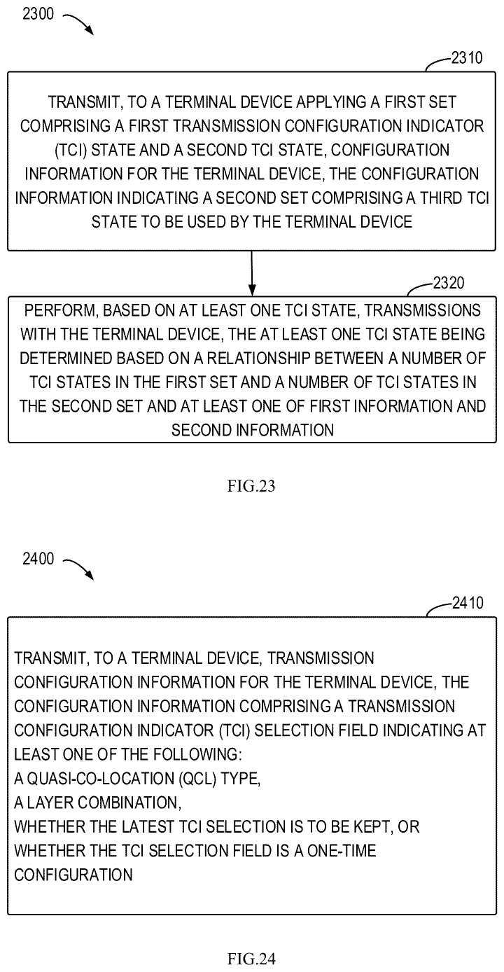

FIG. 24 illustrates a flowchart of a communication method 2400 implemented at a network device in accordance with some embodiments of the present disclosure. For the purpose of discussion, the method 2400 will be described from the perspective of the network device 120 in FIG. 1A.

At block 2410, the network device transmits, to a terminal device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In some example embodiments, the terminal device is applied with a first TCI state and a second device, or the configuration information indicates the first and second TCI states, and wherein, in case of a downlink transmission with a coherent joint transmission (CJT) type or a single frequency network (SFN) type, a first value of the TCI selection field indicates that the first TCI state is used as a reference TCI state and a second value of the TCI selection field indicates that the second TCI state is used as a reference TCI state.

In some example embodiments, the terminal device is applied with a first TCI state and a second device, or the configuration information indicates the first and second TCI states, and wherein, in case of a coherent joint transmission (CJT) type, a first value of the TCI selection field indicates that the first TCI state provides information for QCL type A and the second TCI state provides information for {Doppler shift, Doppler spread}, and a second value of the TCI selection field indicates that the second TCI state provides information for QCL type A and the first TCI state provides information for {Doppler shift, Doppler spread}.

In some example embodiments, the terminal device is applied with a first TCI state and a second device, or the configuration information indicates the first and second TCI states, and wherein, in case of a single frequency network (SFN) type, a first value of the TCI selection field indicates that the first TCI state provides information for QCL type A and the second TCI state provides information for QCL parameters excluding {Doppler shift, Doppler spread}, and a second value of the TCI selection field indicates that the second TCI state provides information for QCL type A and the first TCI state provides information for QCL parameters excluding {Doppler shift, Doppler spread}.

### Example Apparatuses and Devices

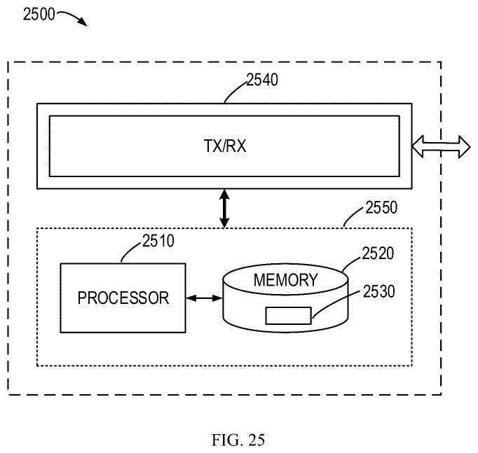

FIG. 25 is a simplified block diagram of a device 2500 that is suitable for implementing embodiments of the present disclosure. The device 2500 can be considered as a further example implementation of any of the devices as shown in FIG. 1A. Accordingly, the device 2500 can be implemented at or as at least a part of the terminal device 110 or the network device 120.

As shown, the device 2500 includes a processor 2510, a memory 2520 coupled to the processor 2510, a suitable transceiver 2540 coupled to the processor 2510, and a communication interface coupled to the transceiver 2540. The memory 2510 stores at least a part of a program 2530. The transceiver 2540 may be for bidirectional communications or a unidirectional communication based on requirements. The transceiver 2540 may include at least one of a transmitter 2542 and a receiver 2544. The transmitter 2542 and the receiver 2544 may be functional modules or physical entities. The transceiver 2540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 2530 is assumed to include program instructions that, when executed by the associated processor 2510, enable the device 2500 to operate in accordance with the embodiments of the present disclosure, as discussed herein with reference to FIGS. 1 to 24. The embodiments herein may be implemented by computer software executable by the processor 2510 of the device 2500, or by hardware, or by a combination of software and hardware. The processor 2510 may be configured to implement various embodiments of the present disclosure. Furthermore, a combination of the processor 2510 and memory 2520 may form processing means 2550 adapted to implement various embodiments of the present disclosure.

The memory 2520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 2520 is shown in the device 2500, there may be several physically distinct memory modules in the device 2500. The processor 2510 may be of any type suitable to the local technical network, and may include one or more of general purpose computers, special purpose computers, microprocessors, digital signal processors (DSPs) and processors based on multicore processor architecture, as non-limiting examples. The device 2500 may have multiple processors, such as an application specific integrated circuit chip that is slaved in time to a clock which synchronizes the main processor.

According to embodiments of the present disclosure, a terminal device comprising a circuitry is provided. The circuitry is configured to: receive, a first message comprising a first configuration indicating a selection of transmission configuration indicator (TCI) state; and determine, a set of TCI states intended for the selection of TCI state based on at least one of the following: a first relationship between a first reception time point of receiving the first configuration and a second reception time point of receiving a second configuration indicating at least one TCI state, the second configuration being comprised in the first message or a second message, the second message being received prior to or after the first message, a second relationship between a first effective time point of the first configuration and a second effective time point of the second configuration, or a third relationship between a first frequency resource associated with the first configuration and a second frequency resource associated with the second configuration. According to embodiments of the present disclosure, the circuitry may be configured to perform any method implemented by the terminal device as discussed above.

According to embodiments of the present disclosure, a terminal device comprising a circuitry is provided. The circuitry is configured to: receive, from a network device, configuration information for the terminal device applying a first set comprising a first transmission configuration indicator (TCI) state and a second TCI state, the configuration information indicating a second set comprising a third TCI state to be used by the terminal device; and perform, by applying at least one TCI state, transmissions with the network device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only. According to embodiments of the present disclosure, the circuitry may be configured to perform any method implemented by the terminal device as discussed above.

According to embodiments of the present disclosure, a terminal device comprising a circuitry is provided. The circuitry is configured to: receive, from a network device, configuration information for the terminal device applying at least one transmission configuration indicator (TCI) state, the configuration information comprising a TCI selection field while without comprising a downlink assignment; and ignore the TCI selection field or determine at least one of first information or a second information from the TCI selection field, wherein, the first information indicates which one of the at least one TCI is to be updated, and the second information indicates whether to continue applying the other TCI state or only apply an indicated TCI state. According to embodiments of the present disclosure, the circuitry may be configured to perform any method implemented by the terminal device as discussed above.

According to embodiments of the present disclosure, a terminal device comprising a circuitry is provided. The circuitry is configured to: receive, from a network device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration. According to embodiments of the present disclosure, the circuitry may be configured to perform any method implemented by the terminal device as discussed above.

According to embodiments of the present disclosure, a network device comprising a circuitry is provided. The circuitry is configured to: transmit, to a terminal device applying a first set comprising a first transmission configuration indicator (TCI) state and a second TCI state, configuration information for the terminal device, the configuration information indicating a second set comprising a third TCI state to be used by the terminal device; and perform, based on at least one TCI state, transmissions with the terminal device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only. According to embodiments of the present disclosure, the circuitry may be configured to perform any method implemented by the network device as discussed above.

According to embodiments of the present disclosure, a network device comprising a circuitry is provided. The circuitry is configured to: transmit, to a terminal device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration. According to embodiments of the present disclosure, the circuitry may be configured to perform any method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a terminal device comprising: a processor configured to cause the terminal device to: receive, a first message comprising a first configuration indicating a selection of transmission configuration indicator (TCI) state; and determine, a set of TCI states intended for the selection of TCI state based on at least one of the following: a first relationship between a first reception time point of receiving the first configuration and a second reception time point of receiving a second configuration indicating at least one TCI state, the second configuration being comprised in the first message or a second message, the second message being received prior to or after the first message, a second relationship between a first effective time point of the first configuration and a second effective time point of the second configuration, or a third relationship between a first frequency resource associated with the first configuration and a second frequency resource associated with the second configuration.

In some embodiments, if the second configuration is absent, the set of TCI states is determined based on one of the following: at least one TCI state being applied prior to the first reception time point, or at least one TCI state to be applied after the first reception time point.

In some embodiments, the set of TCI states intended for the selection of TCI state is one of the following: the at least one TCI state indicated by the second configuration, the second configuration being comprised in the first message, the at least one TCI state indicated by the second configuration, the second configuration being comprised in the different second message received prior to the first message, the at least one TCI state indicated by the second configuration, the second configuration being comprised in the different second message received after the first message, at least one TCI state being applied prior to the first reception time point, or at least one TCI state to be applied after the first reception time point.

In some embodiments, if the first effective time point is earlier than the second effective time point, prior to the first effective time point, a default selection of TCI state is performed among default TCI states; during the first effective time point and the second effective time point, the selection of TCI state indicated by the first configuration is performed among the default TCI states; and after the second effective time point, the selection of TCI state indicated by the first configuration is performed among the at least one TCI state indicated by the second configuration.

In some embodiments, if the second effective time point is earlier than the first effective time point, prior to the second effective time point, a default selection of TCI state is performed among default TCI states; during the second effective time point and the first effective time point, the default selection of TCI state is performed among the at least one TCI state indicated by the second configuration, and after the first effective time point, the selection of TCI state indicated by the first configuration is performed among the at least one TCI state indicated by the second configuration.

In some embodiments, if the second configuration is absent, prior to the first effective time point, a default selection of TCI state is performed, and after the first effective time point, the selection of TCI state indicated by the first configuration is performed.

In some embodiments, if the first configuration is absent, prior to the second effective time point, default TCI states is applied, and after the second effective time point, the at least one TCI state indicated by the second configuration is applied.

In some embodiments, if the first and second frequency resources belong to a same bandwidth part (BWP)/component carrier (CC) list, the first message further indicates information about the first frequency resource, the selection of TCI state is performed based on a plurality of TCI states associated with the first frequency resource.

In some embodiments, if the first and second frequency resources belong to different bandwidth part (BWP)/component carrier (CC) lists, the first message further indicates information about the first frequency resource, and the processor is further configured to cause the terminal device to: activate a plurality of TCI states associated with the first frequency resource; and prior to a completion of the activation, default TCI states is applied.

In some embodiments, if a number of the set of TCI states is less than two, the processor is further configured to cause the terminal device to: ignore the first configuration; not expect to receive the first configuration; expect all the codepoints are mapped with two TCI states; apply the set of TCI states; apply at least one default TCI state; or perform the selection of TCI state on default TCI states.

In some embodiments, the processor is further configured to cause the terminal device to: determine a number of the set of TCI states is less than two if at least one of the following: a number of TCI states configured by a radio resource control (RRC) signalling is one, TCI states configured by an RRC have not been activated by MAC CE, a MAC CE only maps one TCI state for one TCI codepoint, a number of TCI states activated by a MAC CE is one the second configuration is absent, the at least one TCI state indicated by the second configuration has not been activated, or the at least one TCI state indicated by the second configuration is associated with a bandwidth part (BWP)/component carrier (CC) list different from a BWP/CC list associated with the first configuration.

In some embodiments, the default TCI states are one of the following: a set of TCI states each of which is configured with a lower or higher identity, a set of TCI states corresponding to a set of codepoints, each of the set of codepoints is configured with a lower or higher index, at least one latest TCI state, quasi-co-location (QCL) assumption determined during an initial random access or a latest random access, QCL assumption for receiving scheduling information of downlink transmissions, or QCL assumption of at least one associated control resource set (CORESET).

In some embodiments, the default selection of TCI state is one of the following: a selection of TCI state configured by a radio resource control (RRC) signalling; selecting the first TCI state if a number of the set of TCI state is larger than one; selecting two TCI states if the set of TCI states comprise at least two TCI states; selecting a TCI state that is applied to reception with the first configuration; selecting the at least one TCI state indicated by the second configuration; selecting at least TCI state as the latest applied selection of TCI state.

In an aspect, it is proposed a terminal device comprising: a processor configured to cause the terminal device to: receive, from a network device, configuration information for the terminal device applying a first set comprising a first transmission configuration indicator (TCI) state and a second TCI state, the configuration information indicating a second set comprising a third TCI state to be used by the terminal device; and perform, by applying at least one TCI state, transmissions with the network device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In some embodiments, any of the first, second, third TCI state is a joint TCI state, a separate TCI state or a pair of separate TCI states; and wherein, any of the at least one of the TCI state is a joint TCI state, a separate TCI state or a pair of separate TCI states.

In some embodiments, applying the at least one TCI state comprising at least one of the following: applying the second and third TCI states, applying the first and third TCI states, or applying the third TCI state only.

In some embodiments, the first and second information is indicated separately or jointly, and wherein at least one of the first and second information is indicated in at least one of the following: a TCI field in downlink control information (DCI), a TCI selection field in DCI, a TCI state activation field in medium access control (MAC) control element (CE), or an information element (IE) in a radio resource control (RRC) signalling.

In some embodiments, at least one of the first and second information is indicated by a codepoint in a TCI field in downlink control information (DCI), and wherein, a first value of the codepoint indicates that the first TCI state is to be updated with the third TCI state and the second TCI state continues to be applied; a second value of the codepoint indicates that the second TCI state is to be updated with the third TCI state and the first TCI state continues to be applied; or a third value of the codepoint indicates only the third TCI state is to be applied.

In some embodiments, at least one of the first and second information is indicated by a TCI state activation field in a medium access control (MAC) control element (CE), and wherein the TCI state activation field comprises: at least one codepoint indicating at least one third TCI state, at least one first parameter used for indicating the first information corresponding to the at least one third TCI state, and at least one second parameter used for indicating the second information corresponding to the at least one third TCI state.

In some embodiments, each of the at least one third TCI state is indicated by a bit string of an identity of the third TCI state, and the most significant bit of the bit string is used for indicating either the first information or the second information for the third TCI state.

In some embodiments, at least one of the first and second information is jointly indicated by: a TCI field in DCI, and one of a TCI selection field in the DCI and an information element (IE) in a radio resource control (RRC) signalling.

In some embodiments, a reserved value of the TCI selection field is used for indicating the second information.

In some embodiments, a first value of the codepoint in the TCI field and a reserved value of the TCI selection field jointly indicate that the first TCI state is to be updated with the third TCI state and the second TCI state continues to be applied; or a second value of the codepoint in the TCI field and the reserved value of the TCI selection field jointly indicate that the second TCI state is to be updated with the third TCI state and the first TCI state continues to be applied.

In some embodiments, a first value of the codepoint in the TCI field and a reserved value of the TCI selection field jointly indicate that the first TCI state is to be updated with the third TCI state or only the third TCI state is to be applied; or a second value of the codepoint in the TCI field and the reserved value of the TCI selection field jointly indicate that the second TCI state is to be updated with the third TCI state or only the third TCI state is to be applied.

In some embodiments, the TCI selection field or the IE in the RRC signalling is used for indicating the first information.

In some embodiments, a first value of a codepoint in the TCI field and a second value of either the TCI selection field or the IE jointly indicates that the first TCI state is to be updated with the third TCI state and the second TCI state continues to be applied; or a third value of the codepoint in the TCI field and a fourth value of either the TCI selection field or the IE jointly indicates that the second TCI state is updated with the third TCI state and the third TCI state continues to be applied.

In some embodiments, the processor is further configured to cause the terminal device to: transmit, to the network device, capability-related information indicating whether a capability of updating one of the first and second TCI states while continuing applying the other one of the first and second TCI states is supported by the terminal device.

In some embodiments, the processor is further configured to cause the terminal device to: if the capability is not supported by the terminal device, in case that the number of TCI states in the second set is one, only apply the third TCI state.

In an aspect, it is proposed a terminal device comprising: a processor configured to cause the terminal device to: receive, from a network device, configuration information for the terminal device applying at least one transmission configuration indicator (TCI) state, the configuration information comprising a TCI selection field while without comprising a downlink assignment; and ignore the TCI selection field or determine at least one of first information or a second information from the TCI selection field, wherein, the first information indicates which one of the at least one TCI is to be updated, and the second information indicates whether to continue applying the other TCI state or only apply an indicated TCI state.

In an aspect, it is proposed a terminal device comprising: a processor configured to cause the terminal device to: receive, from a network device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In some embodiments, the terminal device is applied with a first TCI state and a second device, or the configuration information indicates the first and second TCI states, and wherein, in case of a downlink transmission with a coherent joint transmission (CJT) type or a single frequency network (SFN) type, a first value of the TCI selection field indicates that the first TCI state is used as a reference TCI state and a second value of the TCI selection field indicates that the second TCI state is used as a reference TCI state.

In some embodiments, the terminal device is applied with a first TCI state and a second device, or the configuration information indicates the first and second TCI states, and wherein, in case of a coherent joint transmission (CJT) type, a first value of the TCI selection field indicates that the first TCI state provides information for QCL type A and the second TCI state provides information for {Doppler shift, Doppler spread}, and a second value of the TCI selection field indicates that the second TCI state provides information for QCL type A and the first TCI state provides information for {Doppler shift, Doppler spread}.

In some embodiments, the terminal device is applied with a first TCI state and a second device, or the configuration information indicates the first and second TCI states, and wherein, in case of a single frequency network (SFN) type, a first value of the TCI selection field indicates that the first TCI state provides information for QCL type A and the second TCI state provides information for QCL parameters excluding {Doppler shift, Doppler spread}, and a second value of the TCI selection field indicates that the second TCI state provides information for QCL type A and the first TCI state provides information for QCL parameters excluding {Doppler shift, Doppler spread}.

In an aspect, it is proposed a network device comprising: a processor configured to cause the network device to: transmit, to a terminal device applying a first set comprising a first transmission configuration indicator (TCI) state and a second TCI state, configuration information for the terminal device, the configuration information indicating a second set comprising a third TCI state to be used by the terminal device; and perform, based on at least one TCI state, transmissions with the terminal device, the at least one TCI state being determined based on a relationship between a number of TCI states in the first set and a number of TCI states in the second set and at least one of the following: first information indicating which one of the first and second TCI states is to be updated by the third TCI state, or second information indicating whether to continue applying the other one of the first and second TCI states or indicating whether to apply the third TCI state only.

In some embodiments, any of the first, second, third TCI state is a joint TCI state, a separate TCI state or a pair of separate TCI states; and wherein, any of the at least one of the TCI state is a joint TCI state, a separate TCI state or a pair of separate TCI states.

In some embodiments, the first and second information is indicated separately or jointly, and wherein at least one of the first and second information is indicated in at least one of the following: a TCI field in downlink control information (DCI), a TCI selection field in DCI, a TCI state activation field in medium access control (MAC) control element (CE), or an information element (IE) in a radio resource control (RRC) signalling.

In some embodiments, at least one of the first and second information is indicated by a codepoint in a TCI field in downlink control information (DCI), and wherein, a first value of the codepoint indicates that the first TCI state is to be updated with the third TCI state and the second TCI state continues to be applied; a second value the codepoint indicates that the second TCI state is to be updated with the third TCI state and the first TCI state continues to be applied; a third value the codepoint indicates that only the third TCI state is to be applied.

In some embodiments, at least one of the first and second information is indicated by a TCI state activation field in a medium access control (MAC) control element (CE), and wherein the TCI state activation field comprises: at least one codepoint indicating at least one third TCI state, at least one first parameter used for indicating the first information corresponding to the at least one third TCI state, and at least one second parameter used for indicating the second information corresponding to the at least one third TCI state.

In some embodiments, each of the at least one third TCI state is indicated by a bit string of an identity of the third TCI state, and the most significant bit of the bit string is used for indicating either the first information or the second information for the third TCI state.

In some embodiments, at least one of the first and second information is jointly indicated by: a TCI field in DCI, and one of a TCI selection field in the DCI and an information element (IE) in a radio resource control (RRC) signalling.

In some embodiments, a reserved value of the TCI selection field is used for indicating the second information.

In some embodiments, a first value of the codepoint in the TCI field and a reserved value of the TCI selection field jointly indicate that the first TCI state is to be updated with the third TCI state and the second TCI state continues to be applied; or a second value of the codepoint in the TCI field and the reserved value of the TCI selection field jointly indicate that the second TCI state is to be updated with the third TCI state and the first TCI state continues to be applied.

In some embodiments, a first value of the codepoint in the TCI field and a reserved value of the TCI selection field jointly indicate that the first TCI state is to be updated with the third TCI state or only the third TCI state is to be applied; or a second value of the codepoint in the TCI field and the reserved value of the TCI selection field jointly indicate that the second TCI state is to be updated with the third TCI state or only the third TCI state is to be applied.

In some embodiments, the TCI selection field or the IE in the RRC signalling is used for indicating the first information.

In some embodiments, a first value of a codepoint in the TCI field and a second value of either the TCI selection field or the IE jointly indicates that the first TCI state is to be updated with the third TCI state and the second TCI state continues to be applied; or a third value of the codepoint in the TCI field and a fourth value of either the TCI selection field or the IE jointly indicates that the second TCI state is updated with the third TCI state and the third TCI state continues to be applied.

In some embodiments, the network device receives capability-related information indicating whether updating one of the first and second TCI states while continuing applying the other one of the first and second TCI states is supported by the terminal device.

In an aspect, it is proposed a network device comprising: a processor configured to cause the network device to: transmit, to a terminal device, transmission configuration information for the terminal device, the configuration information comprising a transmission configuration indicator (TCI) selection field indicating at least one of the following: a quasi-co-location (QCL) type, a layer combination, whether the latest TCI selection is to be kept, or whether the TCI selection field is a one-time configuration.

In some embodiments, the terminal device is applied with a first TCI state and a second device, or the configuration information indicates the first and second TCI states, and wherein, in case of a downlink transmission with a coherent joint transmission (CJT) type or a single frequency network (SFN) type, a first value of the TCI selection field indicates that the first TCI state is used as a reference TCI state and a second value of the TCI selection field indicates that the second TCI state is used as a reference TCI state.

In some embodiments, the terminal device is applied with a first TCI state and a second device, or the configuration information indicates the first and second TCI states, and wherein, in case of a coherent joint transmission (CJT) type, a first value of the TCI selection field indicates that the first TCI state provides information for QCL type A and the second TCI state provides information for {Doppler shift, Doppler spread}, and a second value of the TCI selection field indicates that the second TCI state provides information for QCL type A and the first TCI state provides information for {Doppler shift, Doppler spread}.

In some embodiments, the terminal device is applied with a first TCI state and a second device, or the configuration information indicates the first and second TCI states, and wherein, in case of a single frequency network (SFN) type, a first value of the TCI selection field indicates that the first TCI state provides information for QCL type A and the second TCI state provides information for QCL parameters excluding {Doppler shift, Doppler spread}, and a second value of the TCI selection field indicates that the second TCI state provides information for QCL type A and the first TCI state provides information for QCL parameters excluding {Doppler shift, Doppler spread}.

In an aspect, a terminal device comprises: at least one processor; and at least one memory coupled to the at least one processor and storing instructions thereon, the instructions, when executed by the at least one processor, causing the device to perform the method implemented by the terminal device discussed above.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 25. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, a configuration indicating a first transmission configuration indicator (TCI) state and a second TCI state; and
receiving a downlink transmission applying at least one TCI state of the first TCI state and the second TCI state,
wherein:
the at least one TCI state is the first TCI state, in a case where an offset between a reception of a downlink control information (DCI) and a time point for the downlink transmission is less than a time duration threshold,
the at least one TCI state is indicated by a TCI selection field in the DCI, in a case where the TCI selection field is configured in the DCI and the offset between the reception of the DCI and a time point for the downlink transmission is larger than the time duration threshold,
the at least one TCI state is both the first TCI state and the second TCI state, in a case where the TCI selection field is not configured in the DCI and the offset between the reception of the DCI and the time point for the downlink transmission is larger than the time duration threshold.

22. The method of claim 21, comprising:
receiving, from the network device, a medium access control (MAC) control element (CE), wherein the MAC CE comprises a first field indicating a third TCI state and a second field indicating which one of the first TCI state and the second TCI state is to be updated by the third TCI state.

23. The method of claim 21, wherein the TCI selection field indicates a TCI state selected from the first TCI state and the second TCI state.

24. A method, performed by a network device, the method comprising:
transmitting, to a terminal device, a configuration indicating a first transmission configuration indicator (TCI) state and a second TCI state; and
performing a downlink transmission applying at least one TCI state of the first TCI state and the second TCI state,
wherein:
the at least one TCI state is the first TCI state, in a case where an offset between a reception of a downlink control information (DCI) and a time point for the downlink transmission is less than a time duration threshold,
the at least one TCI state is indicated by a TCI selection field in the DCI, in a case where the TCI selection field is configured in the DCI and the offset between the reception of the DCI and a time point for the downlink transmission is larger than the time duration threshold,
the at least one TCI state is both the first TCI state and the second TCI state, in a case where the TCI selection field is not configured in the DCI and the offset between the reception of the DCI and the time point for the downlink transmission is larger than the time duration threshold.

25. The method of claim 24, comprising:
transmitting, to the terminal device, a medium access control (MAC) control element (CE), wherein
the MAC CE comprises a first field indicating a third TCI state and a second field indicating which one of the first TCI state and the second TCI state is to be updated by the third TCI state.

26. The method of claim 24, wherein the TCI selection field indicates a TCI state selected from the first TCI state and the second TCI state.

27. A terminal device, comprising a processor configured to cause the terminal device to:
receive, from a network device, a configuration indicating a first transmission configuration indicator (TCI) state and a second TCI state; and
receive a downlink transmission applying at least one TCI state of the first TCI state and the second TCI state,
wherein:
the at least one TCI state is the first TCI state, in a case where an offset between a reception of a downlink control information (DCI) and a time point for the downlink transmission is less than a time duration threshold,
the at least one TCI state is indicated by a TCI selection field in the DCI, in a case where the TCI selection field is configured in the DCI and the offset between the reception of the DCI and a time point for the downlink transmission is larger than the time duration threshold,
the at least one TCI state is both the first TCI state and the second TCI state, in a case where the TCI selection field is not configured in the DCI and the offset between the reception of the DCI and the time point for the downlink transmission is larger than the time duration threshold.

28. The terminal device of claim 27, wherein the processor is configured to cause the terminal device to:
receive, from the network device, a medium access control (MAC) control element (CE), wherein the MAC CE comprises a first field indicating a third TCI state and a second field indicating which one of the first TCI state and the second TCI state is to be updated by the third TCI state.

29. The terminal device of claim 27, wherein the TCI selection field indicates a TCI state selected from the first TCI state and the second TCI state.
